(19) United States
(12) Patent Application Publication
(10) Pub. No.: US 2012/0221308 A1
(43) Pub. Date: Aug. 30, 2012

(54) Portable Drilling Simulation System

(75) Inventor: Lixue Chen, Chengdu (CN)

(73) Assignee: CHENGDU ESIMTECH PETROLEUM EQUIPMENT SIMULATION TECHNOLOGY EXPLOITATION CO., LTD., Gaoxin Chengdu, Sichuan (CN)

(21) Appl. No.: 13/508,033

(22) PCT Filed: Jul. 3, 2010
(86) PCT No.: PCT/CN2010/074959

§ 371 Date: May 3, 2012

(30) Foreign Application Priority Data
Nov. 10, 2009 (CN) 200910216186.3

(51) Int. Cl. G06G 7/48

(52) U.S. Cl. 703/10

(57) ABSTRACT

A portable drilling simulation system includes a main control computer, a graphic processing computer, a choke console and a blowout preventer console. The main control computer, the graphic processing computer, the choke console and the blowout preventer console are interconnected by a network and serial ports. The blowout preventer console includes a blowout preventer control panel. On the left of the blowout preventer control panel is provided a blowout preventer control zone. On the upper right is provided a throttling manifold control zone. On the lower right is provided a high-pressure manifold control zone. The flow plug console includes a flow plug control panel. A main control program runs on the main control computer and a graphic processing program runs on the graphic computer. The regular blowout preventer console, the regular throttling manifold, the regular high-pressure manifold and the regular flow plug console are integrated into the portable drilling simulation system, thus the simulated operation of several apparatuses on the control panel is realized.

### BACKGROUND OF THE PRESENT INVENTION

1. Field of Invention

The invention relates to a drilling simulation device, more particularly to a portable drilling simulation system.

2. Description of Related Arts

Petroleum industry is a technology-intensive industry and drilling operation is one of the important means for determining reserve and increasing yield. Extremely large risk is encountered during petroleum drilling operation owing to limited production conditions and complex underground situations in petroleum drilling. In order to acquire better production efficiency and economical benefit and lower the occurrence of human accident, it is tremendously important to bring drilling site operating staff and engineering technicians into technical skill training.

At present, training for drilling operation is mainly performed at the production site, wherein training contents are greatly limited owing to the constraint of various conditions and factors. Therefore, training systematicness, training effect and the number of training staff are all heavily affected.

### SUMMARY OF THE PRESENT INVENTION

The objective of the invention is to overcome the defects in conventional training technology for petroleum drilling operation and provide a portable drilling simulation system based on computer emulation technology. The simulator achieves vivid simulation of drilling process and procedure with reference to actual operation flow at the drilling operation site, thus improving training effect, shortening training cycle, lowering training cost, and improving the operating level of driller and captain and their capability of analyzing, judging and handling complex underground situations.

The objective of the invention is implemented through the technical proposal as follows. The portable drilling simulation system comprises a main control computer, a graphic processing computer, a choke console, and a blowout preventer console. The main control computer and the graphic processing computer are interconnected via a local area network. The main control computer is connected with the choke console and the blowout preventer console via serial ports respectively.

The blowout preventer console comprises a chassis and an internal control plate. The front face of the chassis comprises a blowout preventer control panel. A blowout preventer control zone is arranged at the left side on the blowout preventer control panel, a choke manifold control zone is arranged at the upper part of the right side, and a high-pressure manifold control zone is arranged at the lower part of the right side.

The blowout preventer control zone is provided with a ram blowout preventer oil pressure gauge, a ring blowout preventer oil pressure gauge, a gas source switch, a ring switch, a ring on indicator, a ring off indicator, an upper pipe ram switch, an upper pipe ram on indicator, an upper pipe ram off indicator, a blind ram switch, a blind ram on indicator, a blind ram off indicator, a kill manifold switch, a kill manifold on indicator, a kill manifold off indicator, a blowout preventer valve switch, a blowout preventer valve off indicator, a blowout preventer valve on indicator, a lower pipe ram switch, a lower pipe ram on indicator, and a lower pipe ram off indicator.

Crossing points a, b, c, d, e and f are formed by parallel lines and vertical lines on the choke manifold control zone in a ‘+’ crossing connection manner. The flat valve B is arranged on the parallel line at the left end of the crossing point a. The flat valve E is arranged on the vertical line at the left end of the crossing point a. The flat valve A is arranged on the vertical line at the upper end of the crossing point b. The flat valves D and G are sequentially arranged on the vertical line at the lower end of the crossing point b. The flat valve C is arranged on the parallel line at the right end of the crossing point c. The flat valve F is arranged on the vertical line at the lower end of the crossing point b. The flat valves H and I are arranged on the parallel line at the right end of the crossing point d and the parallel line at the left end of the crossing point e. The hydraulic indicator is arranged on the vertical line at the lower end of the crossing point d. The blowout preventer valve switch indicator is arranged on the vertical line at the lower end of the crossing point e. The flat vales are arranged on the parallel line at the right end of the crossing point e and the parallel line at the left end of the crossing point f. The manual throttle valve (28) is arranged on the vertical line at the lower end of the crossing point f.

Crossing points g, h, i, j and k are formed by parallel lines and vertical lines on the high-pressure manifold control zone (4) in a ‘+’ crossing connection manner. The flat valve L is arranged on the vertical line at the upper end of the crossing point h. The flat valve N is arranged on the vertical line at the lower end of the crossing point h, the . The flat valve M is arranged on the vertical line at the upper end of the crossing point i. The flat valve O is arranged on the vertical line at the lower end of the crossing point i. The flat valve P is arranged on the parallel line at the left end of the crossing point K. The flat valve Q is arranged on the vertical line at the lower end of the crossing point k.

The internal control plate of the blowout preventer console comprises a single chip microcomputer and a peripheral circuit, the gas source switch, the ring switch, the upper pipe ram switch, the blind ram switch, the kill manifold switch, the blowout preventer valve switch, the lower pipe ram switch, and flat plates A to Q which are connected to the latch via the buffer. The output of the latch A is connected with one data input/output port of the single chip microcomputer. A manual throttle valve is connected with a multipath selector. The output of the multipath selector is connected with an operational amplifier. The output of the operational amplifier is connected to the latch A via an AD converter. The output of the latch A is connected with one data input/output port of the single chip microcomputer, the input/output port also serves as a data output port. The output of the input/output port is connected with the latch B. The output of the latch B is connected with the DA convertor. The output of the DA converter is connected with an operational amplifier B. The output of the operational amplifier B is connected with the field effect transistor. The output of the field effect transistor is connected with the ram blowout preventer oil pressure gauge and the ring blowout preventer oil pressure gauge respectively. Another data input/output port of the single chip microcomputer is connected with the parallel interface. The parallel interface is connected with the driver. The output of the driver is connected with the ring on indicator, the ring off indicator, the upper pipe ram on indicator, the upper pipe ram off indicator, the blind ram on indicator, the blind ram off indicator, the kill manifold on indicator, the kill manifold off indicator, the blowout preventer valve off indicator, the blowout preventer valve on indicator, the lower pipe ram on indicator, the lower pipe ram off indicator, the hydraulic indicator, and the blowout preventer valve switch indicator. Two outputs of the third input/output port of the single chip microcomputer are connected with an address decoder via the latch B. The decoding output of the address decoder is connected with the parallel interface, and the selection control ends of the DA converter and the AD converter respectively.

The ram blowout preventer oil pressure gauge is used for displaying ram blowout preventer oil pressure value. The ring blowout preventer oil pressure gauge is used for displaying ring blowout preventer oil pressure value. The gas source switch, the ring switch, the upper pipe ram switch, the blind ram switch, the kill manifold switch, the blowout preventer valve switch, and the lower pipe ram switch are respectively used for turning on or off gas source, ring blowout preventer, upper pipe ram, blind ram, kill manifold, blowout preventer valve, and lower pipe ram; the ring on/off indicators. The upper pipe ram on indicator, the blind ram on indicator, the kill manifold on indicator, the blowout preventer valve on indicator, and the lower pipe ram on indicator are respectively used for indicating the on/off condition of ring blowout preventer, upper pipe ram, blind ram, kill manifold, blowout preventer valve, and lower pipe ram. The hydraulic indicator is used for displaying the adoption of a hydraulic adjustment throttle valve. The blowout preventer valve switch indicator on the choke manifold is used for displaying blowout preventer valve switch. The manual throttle valve is used for manually adjusting the opening of throttle valve. The flat valves are used for turning on/off the flat vales.

The working flow of the blowout preventer console is approximately as follows. An initialization program completes the initialization of ports on the internal control plate, such as serial ports and parallel ports, in order to realize point-to-point communication with a remote console, and also to complete the initial value setting of the indicators on the panel and relevant parameters. Then, switch quantity is read and stored in an internal buffer so that switch states are sent from the serial ports to a main control computer. An A/D result is then read and stored in the internal buffer so that an A/D-converted value is sent from the serial ports to the main control computer. Afterwards, data are output to the indicators to control the display of the indicators based on the switch states. Data are output to the pressure gauge for displaying initial values. The ram blowout preventer oil pressure gauge and the ring blowout preventer oil pressure gauge display the values of initial state. Then, a command and data from the main control computer are received. The single chip microcomputer receives the command and data from the main control computer in an interruption manner. The interruption process is to read the value of the serial port SBuf of the single chip microcomputer. The command sent from the main control computer is received if SBuf=1 is true. Then, returning from interruption is performed. Data are output to D/A for controlling the display of the ram blowout preventer oil pressure gauge and the ring blowout preventer oil pressure gauge. Finally, the single chip microcomputer sends the data to the main control computer in an interruption manner. The interruption process is to read the value of the serial port SBuf of the single chip microcomputer. The data is sent to the main control computer if SBuf=1 is false. Then, returning from interruption is performed and the above steps are cycled.

The choke console comprises a chassis and an internal control circuit board. The front face of the chassis comprises a choke control panel. The choke control panel is provided with a vertical pipe pressure gauge, a sleeve pressure gauge, a throttle valve opening gauge, a display set, a knob set, a switch set, and a light-mounted button set, wherein the display set comprises a pump stroke display, a parameter display A and a parameter display B. The knob set comprises a throttle valve speed-adjusting knob, an increase button A, a decrease button A, an increase button B, a decrease button B, an accelerator adjusting knob, and a pump stroke adjusting knob. The switch set comprises a throttle regulating vale switch, a pump clutch switch, a rotary table clutch switch, a cathead selection switch, and a roller clutch switch. The light-mounted button set comprises a No. 1 light-mounted button, a No. 2 light-mounted button, a No. 3 light-mounted button, a No. 4 light-mounted button, a No. 5 light-mounted button, a No. 6 light-mounted button, a No. 7 light-mounted button, a No. 8 light-mounted button, a No. 11 light-mounted button, a No. 12 light-mounted button, a No. 13 light-mounted button, a No. 14 light-mounted button, a No. 15 light-mounted button, a No. 16 light-mounted button, a No. 17 light-mounted button, and a No. 18 light-mounted button.

The internal control circuit board of the choke console comprises a single chip microcomputer and a peripheral circuit thereof. Twenty five switch quantity inputs, including the light-mounted button set, the switch set, the increase button A, the decrease button A, the increase button B, and the decrease button B, are connected with the buffer. The output of the buffer is connected with the latch A. The output of the latch A is connected to one data input/output port of the single chip microcomputer. Three analog quantities, including the throttle valve speed-adjusting knob, the accelerator adjusting knob and the pump stroke adjusting knob, are connected with the multipath selector. The output of the multipath selector is connected with the operational amplifier A. The output of the operational amplifier A is connected with the AD converter. The output of the AD converter is connected with the latch A. The input/output port also serves as a data output port. The output of the data output port is connected with the latch B. The output of the latch B is divided into two paths one of which is connected with the DA converter. The output of the DA converter is connected with the operational amplifier B. The output of the operational amplifier B is connected with the field effect transistor. The output of the field effect transistor is connected with the vertical pipe pressure gauge, the sleeve pressure gauge and the throttle valve opening gauge. The other path of the output of the latch B is connected with a parallel port. The output of the parallel port is connected with a pump stroke and parameter display driver. The output of the pump stroke and parameter display driver is connected with the pump stroke display, the parameter display A and the parameter display B. Another data input/output port of the single chip microcomputer is connected with the parallel interface. The parallel interface is connected with a driver. The output of the driver is connected with the light-mounted button set. Two outputs of the third input/output port of the single chip microcomputer are connected with the address decoder via the latch B. The output of the address decoder is connected with the parallel interface and the selection ends of the DA converter and the AD converter respectively.

The pump stroke and parameter display driver comprises an address buffer, a data buffer, a comparator, a decoder, a dip switch, a nixie tube drive chip, and a nixie tube. The input ends of the address buffer and the data buffer are both connected with the parallel port. The output of the data buffer is connected with the nixie tube drive chip. The output of the nixie tube drive chip is connected with the nixie tubes of the pump stroke display, the parameter display A and the parameter display B respectively. The output of the address buffer is connected with the comparator and the decoder respectively. The other input end of the comparator is connected with the dip switch, the. The output of the comparator is connected with the enabling end of the decoder. One output end of the decoder is connected with the writing control end of the nixie tube drive chip and the other output end of the decoder is connected with the mode control end of the nixie tube drive chip via a trigger.

The working flow of the choke console is approximately as follows. The initialization of ports on the internal control plate, such as serial ports and parallel ports, and the initial value setting of the indicators on the panel and relevant parameters are completed in system initialization. Then, switch quantity is read and stored in an internal buffer so that switch states are sent from the serial ports to a main control computer. An A/D result is then read and stored in the internal buffer so that an A/D-converted value is sent from the serial ports to the main control computer. Afterwards, data is output to the indicators. The single chip microcomputer receives the command and data from the main control computer in an interruption manner and then send the data from the parallel ports to a display control plate for displaying accumulative pump stroke, mud density, heavy mud volume and other relevant parameter values, for example discordance of parameters with operating requirements and increase or decrease of parameter values. Then, data are output to D/A for controlling the display of instruments for vertical tube pressure, sleeve pressure, throttle valve opening and the like. Afterwards, the single chip microcomputer sends the data to the main control computer in an interruption manner. Finally, return is performed and the above steps are cycled.

The flow of the choke console for receiving the command and sending the data in an interruption manner is approximately as follows. The value of the serial port SBuf of the single chip microcomputer is read. Data are sent to the main control computer if SBuf=1. Otherwise, the command sent from the main control computer is received, and then return from interruption is performed.

The main control computer comprises a computer and a main control program running thereon. The graphic computer comprises a computer and a graphic processing program running thereon.

The main control program comprises a drilling process module, a system management module, an intelligent scoring module, and a communication module. The main control program is communicated with a front end hardware equipment (the blowout preventer console and the choke console) via the communication module to obtain the state of the hardware equipment in real-time, for example parameters such as rotation number of rotary table, brake state, mud discharging quantity and mud density needed to be obtained in the simulation for drilling process. Then, a typical drilling process is simulated by means of relevant mathematical models to finish the following tasks:

1. A control command is sent to the graphic processing program via TCP/IP protocol, and thus the graphic processing program can be driven to generate an animation process that is synchronous with the operation of the hardware equipment.

2. An intelligent scoring system is realized.

3. A signal is fed back to the front end hardware, enabling the parameter display of front end instruments to accord with onsite situation.

The system management module comprises a system self-inspection and system setting sub-module, function check for the choke console, the blowout preventer console, and choke manifolds, and that high-pressure manifolds thereof are completed mainly in system self-inspection in order to determine whether the front end equipment operates normally The specific method is as follows. The state of various switches, buttons or valves of the front end hardware equipment is changed so that synchronous change can be seen in the main control program. In this case, whether the front end equipment operates normally can be observed. System setting is used for correcting major components of the front end hardware equipment, mainly including brake correction, foot accelerator correction, needle valve correction, hand accelerator 1 correction, hand accelerator 2 correction, hand accelerator 3 correction, throttling speed correction, system operation setting, and etc . . . .

The intelligent scoring module is mainly used for automatically scoring the training process. Scoring is related mainly to two factors. 1. Operating flow: all the operating flows of trainees are recorded in the system. The operating flow of trainee is compared with a preset operating flow in the system upon the completion of trainee examination to evaluate the accordance of the two flows and score the operating flow of trainees on this basis. 2. Operating level: in addition to the grasp of corrective operating flow by trainees, their operating flows shall be taken into consideration in comprehensively evaluating the technical level of trainees, e.g. whether the selection for weight on bit during drilling in is appropriate; whether drilling is even; for the problem whether the control for pressure during killing meets the demand of killing constructor. The system determines the operating level score by adopting a method for recording relevant data curves in the operating flow and comparing the data curves with standard curves afterwards. The scoring process is as follows: a trainee logs in the system, begins examination and completes corresponding operations, and the system scores automatically based upon relevant standards to obtain a final score.

The graphic processing program comprises a scene initialization module, a process animation control module, a collision processing module, and a render effect module. A vivid, virtual drilling environment is created by means of full three-dimensional animation so that trainees feel as if they were in a real drilling environment. Thus, the mental resilience of trainees in accident handling is improved and better training effect is obtained. The four modules have the following functions:

Scene initialization: the current scene of every operation differs owing to the complexity of drilling process and the operability of virtual training. Before a new operation begins, the graphic program initializes the current scene after receiving an operation command sent from the control computer, for example the current number, state and position of operating components on a drilling platform.

Process animation control: in the process of completing the specified process operation, every action from drilling console is converted into a digital signal. The digital signal is transmitted to the main control computer. Protocol data are then sent to the graphic program by the main control computer and the graphic program gives a specific response after the acquisition of parameters. Motion parameters, specific motions and view selection (including aboveground visual angle, underground visual angle, blowout preventer visual angle, multi-view display, and etc.) of various control systems on drilling platform are reflected on a graphic machine.

Collision processing: the situation of ‘wall through’ is not allowed in the motion simulation process of three-dimensional graphics. Therefore, collision detection shall be performed on motion objects. To cause model motion to be realistic, a drilling simulator visual simulating system certainly includes collision detecting and processing parts.

Render effect: simulation for flame, bubble, liquid jetting effects is realized. Movie-level illumination effect is accomplished using GLSL and illumination modes like daylight, night and searchlight can be simulated respectively, thus greatly improving graphic effect and sense of reality.

The drilling process module, which comprises an RIH sub-module, a POOH sub-module, a drill-in sub-module, an accident and complex situation handling sub-module, a shut in sub-module, and a killing sub-module, is the most important module in the main control program. Event drive training has no limitation to trainees, who therefore can operate the simulator randomly. The graphic system will reflect reasonable mechanical motions and simultaneously give a voice prompt with regard to erroneous operations. The module is mainly used for cognitive training of new trainees about drilling site and drilling machinery. In technical process training, trainees are required to operate the simulator per its technical process, in order to intensify the comprehension of trainees on the technical process and make trainees master the operation process of the simulator.

Among all the sub-modules, the RIH sub-module is used for simulating the RIH process and trainees are required to master the RIH process correctively to reach the purpose of steady RIH. Its actual flow is as follows:

(a) Normal RIH flow: begin this operation, start up an elevator, then place and make up a stand, move the elevator away, drop a drill bit, take off elevator links, judge whether RIH is performed, if so, return to start up the elevator, otherwise, end this operation.

(b) Set weight flow: begin this operation, perform RIH normally, perform punching and reaming in the event of set weight, end this operation, and return if set weight does not occur.

(c) Fluctuation pressure controlling RIH flow: begin this operation, start up an elevator, then place and make up a stand, move the elevator away, drop a drill bit at low speed, press corresponding button to take off elevator links, judge whether RIH is continued, if so, return to begin this operation, otherwise, end this operation.

The POOH sub-module is used for simulating the POOH process and trainees are required to master the POOH process correctively to reach the purpose of steady POOH. Its actual operating flow is as follows:

(a) Normal POOH flow: begin this operation, lift up a drill bit, unload a stand, pour mud, judge whether POOH is performed, if so, return to begin this operation, otherwise, end this operation.

(b) Getting overpull flow: begin this operation, perform POOH normally, perform circulative freeing in the event of getting overpull, perform back reaming, end this operation, and return to normal POOH in the case of being unstuck.

(c) Suction pressure controlling POOH flow: begin this operation, lift the drill bit at low speed, unload the stand, pour the mud, judge whether POOH is continued, if so, return to lift the drill bit at low speed, otherwise, end this operation.

The drill sub-module is used for simulating typical drilling well condition and trainees are required to master the drilling process correctively to reach the purpose of even drilling and simultaneously to master the drilling technology for complicated formation. Its actual operating flow is as follows:

(a) Normal drilling and stand makeup flow: begin this operation, circulate mud, perform light press and running in, perform drilling normally, make up the stand, and drop by a certain depth to end this operation.

(b) Drilling flow under different formation drillabilities: begin this operation, circulate mud, perform light press and running in, drill by 1 meter at a first formation, drill by 1 meter at a second formation, drill by 1 meter at a third formation, take out drilling pipe, and end this operation.

(c) Drilling flow under bouncing: begin this operation, perform drilling normally if not bouncing occurs, lift up drilling pipe if bouncing occurs, change rotating speed and weight on bit, drop drilling pipe, judge whether bouncing is reduced, return to lift up drilling pipe if bouncing is not reduced, circulate the operation until bouncing is reduced, then ream bouncing sections, and end this operation.

(d) High-pressure formation drilling flow: begin this operation, circulate mud, perform drilling normally, judge whether overflowing occurs, perform drilling normally if not overflowing occurs, otherwise, increase mud density, continue drilling, make up the stand, and finally, end this operation.

(e) Low-pressure formation drilling flow: begin this operation, circulate mud, perform drilling normally, judge whether leakage occurs, perform drilling normally if not leakage occurs, otherwise, increase mud density, continue drilling, make up the stand, and finally, end this operation.

The accident and complex situation handling sub-module is used for simulating common failures and complex situations in the drilling process. The simulating system creates an accident randomly and requires trainee to judge the type of this accident by means of the phenomenon (mainly changes of a variety of instruments) reflected by simulator and handle the accident properly. Its actual operating flow is as follows:

(a) Adhesion sticking judging and handling flow: begin this operation, lift up the drilling pipe, judge whether there is a ground failure, continue lifting up the drilling pipe if there is no failure, drop the drill bit interruptedly if there is a failure, move the drill bit, circulate mud, free the moved drill bit, then judge whether the moved drill bit has been freed, if not, return to continue freeing until freeing is completed, and end this operation.

(b) Solids settling sticking judging and handling flow: begin this operation, perform POOH normally, judge whether there is solids settling sticking, if not, return to normal POOH, move the drill bit if there is solids settling sticking, circulate mud in small quantity, judge whether pump pressure is normal, if not, return to circulate mud, if so, circulate mud in large quantity, and finally, end this operation.

(c) Balling-up sticking judging and handling flow: begin this operation, perform light press and running in, perform drilling, judge whether there is balling-up sticking, if not, return to normal POOH, if so, circulate mud in larger quantity, perform reaming at high speed, regulate mud performances, continue drilling, and finally, end this operation.

(d) Taper tap fishing flow: begin this operation, wash top of fish, detect fallen fish downwards, judge whether the fallen fish is detected, if not, return to continue downward detection, if so, release thread, make thread, try to lift up the drill pipe, lift up the fallen fish, and finally, end this operation.

(e) Junk milling flow: begin this operation, wash well bottom, mill twice, continue milling until the mill is broken, and end this operation.

The shut in sub-module is used for simulating four shut in conditions. Trainees are required to locate overflowing timely and to be able to shut in well safely and rapidly as required by the ‘four, seven’ motions.

(a) Normal drilling and shutting in: well can be shut in safely, rapidly and correctively during drilling if overflowing occurs. The operating flow is as follows: begin this operation, perform drilling normally, judge whether overflowing occurs, if not, perform drilling normally, if so, open the choke manifold and close ring blowout preventer, upper pipe ram blowout preventer, throttle valve and J2A flat valves, then log well and end this operation.

(b) POOH and shutting in: well shall be shut in safely, rapidly and correctively during POOH if overflowing occurs. The operating flow is as follows: begin this operation, unload a square drilling pipe, lift up a vertical pipe, judge whether overflowing occurs, if not, return to lift up the vertical pipe, if so, make up a drill bit blowout preventer in advance, shut in well, log well, and end this operation.

(c) Drill collar lifting and shutting in: well shall be shut in safely, rapidly and correctively during drill collar lifting if overflowing occurs. The operating flow is as follows: begin this operation, lift up a drill collar, judge whether overflowing occurs, if not, return to lift up the drill collar, if so, make up a blowout preventing single pipe in advance, shut in well, log well, and end this operation.

(d) Emptying and shutting in: well shall be shut in safely, rapidly and correctively during well emptying if overflowing occurs. The operating flow is as follows: begin this operation, judge whether the overflowing quantity is large after the drill collar is lifted up, if so, shut in well, log well and finally end this operation; if not, make up the blowout preventing single pipe in advance, shut in well, log well, and finally end this operation.

The killing sub-module is used for simulating three conventional killing operations. Trainees are required to control wellhead pressure correctively to reach the purpose of succeeding in killing at a time. Its actual operating flow is as follows:

(a) Killing by driller's method: the principle of the killing by driller's method under conventional killing conditions is realized. Wellhead pressure is accurately controlled by means of the control for choke in order to guarantee smooth construction and the success of one-time killing. The operating flow is as follows: begin this operation, set mud pump stroke, discharge contaminated mud, judge whether the contaminated mud is completely discharged, if not, return to discharge the contaminated mud completely, if so, increase mud density, perform killing by weighted mud, judge whether killing is finished, if not, return to continue killing, if so, end this operation.

(b) Killing by engineer's method: the principle of the killing by engineer's method under conventional killing conditions is realized, wellhead pressure is accurately controlled by means of the control for choke in order to guarantee smooth construction and the success of one-time killing. The operating flow is as follows: begin this operation, set mud pump stroke, increase mud density, then perform killing by weighted mud, judge whether killing is finished, if not, return to continue killing, if so, end this operation.

(c) Killing by overweight mud driller's method: the principle of the killing by engineer's method under conventional killing conditions is realized. Wellhead pressure is accurately controlled by means of the control for choke in order to guarantee smooth construction and the success of one-time killing. The operating flow is as follows: begin this operation, prepare overweight mud, pump the overweight mud in, judge whether circulation is finished, if so, regulate mud density, perform killing by killing mud, and judge whether killing is finished, if not, return to continue killing, if so, end this operation.

The invention has the advantages of integrating the conventional blowout preventer console, choke manifold, high-pressure manifold and choke console, thus realizing the simulation operation of a plurality of facilities on one control panel, increasing the training efficiency, shortening the training circle and reducing the training cost. Moreover, the invention has small volume, and therefore, is portable and convenient in use.

### BRIEF DESCRIPTION OF THE DRAWINGS

FIG. 1 is a structural schematic diagram of the portable drilling simulation system.

FIG. 2 is a structural schematic diagram of the control panel of the blowout preventer console.

FIG. 3 is a diagram of the connection relationship between the internal control plate of the blowout preventer console and major components on the control panel.

FIG. 4 is a flow chart of the interruption manner of the internal control plate of the blowout preventer console.

FIG. 5 is a flow chart of the main control program of the internal control plate of the blowout preventer console.

FIG. 6 is a structural schematic diagram of the control panel of the choke console.

FIG. 7 is a diagram of the connection relationship between the internal control plate of the choke console and major components on the control panel.

FIG. 8 is a diagram of the structure of the pump stroke and parameter display driver.

FIG. 9 is a flow chart of the interruption manner of the internal control plate of the choke console.

FIG. 10 is a flow chart of the main control program of the internal control plate of the choke console.

FIG. 11 is a constitution diagram of the main control program on the main control computer.

FIG. 12 is a flow chart of intelligent scoring.

FIG. 13 is a constitution diagram of the graphic processing program on the graphic computer.

FIG. 14 is a flow chart of normal RIH.

FIG. 15 is a flow chart of set weight.

FIG. 16 is a flow chart of fluctuation pressure controlling RIH.

FIG. 17 is a flow chart of normal POOH.

FIG. 18 is a flow chart of getting overpull.

FIG. 19 is a flow chart of suction pressure controlling POOH.

FIG. 20 is a flow chart of normal drilling and stand makeup.

FIG. 21 is a flow chart of drilling under different formation drillabilities

FIG. 22 is a flow chart of drilling under bouncing.

FIG. 23 is a flow chart of high-pressure formation drilling.

FIG. 24 is a flow chart of low-pressure formation drilling.

FIG. 25 is a flow chart of adhesion sticking judging and handling.

FIG. 26 is a flow chart of solids settling sticking judging and handling.

FIG. 27 is a flow chart of balling-up sticking judging and handling.

FIG. 28 is a flow chart of taper tap fishing.

FIG. 29 is a flow chart of junk milling.

FIG. 30 is a flow chart of normal drilling and shutting in.

FIG. 31 is a flow chart of POOH and shutting in.

FIG. 32 is a flow chart of drill collar lifting and shutting in.

FIG. 33 is a flow chart of emptying and shutting in.

FIG. 34 is a flow chart of killing by driller's method.

FIG. 35 is a flow chart of killing by engineer's method.

FIG. 36 is a flow chart of killing by overweight mud driller's method.

In which, 1-control panel, 2-blowout preventer control zone, 3-choke manifold control zone, 4-high pressure manifold control zone, 5-ram blowout preventer oil pressure gauge, 6-ring blowout preventer oil pressure gauge, 7-gas source switch, 8-ring switch, 9-ring on indicator, 10-ring off indicator, 11-upper pipe ram switch, 12-upper pipe ram on indicator, 13-upper pipe ram off indicator, 14-blind ram switch, 15-blind ram on indicator, 16-blind ram off indicator, 17-kill manifold switch, 18-kill manifold on indicator, 19-kill manifold off indicator, 20-blowout preventer valve switch, 21-blowout preventer valve off indicator, 22-blowout preventer valve on indicator, 23-lower pipe ram switch, 24-lower pipe ram on indicator, 25-lower pipe ram off indicator, 26-hydraulic indicator, 27-blowout preventer valve switch indicator, 28-manual throttle valve, A, B, C, D, E, F, G, H, I, J, K, L, M, N, P, Q-flat valve, a, b, c, d, e, f, g, h, i, j, k-crossing point, 29-control panel, 30-vertical pipe pressure gauge, 31-sleeve pressure gauge, 32-pump stroke display, 33-throttle valve opening gauge, 34-throttle regulating vale, 35-throttle valve speed-adjusting knob, 36-No. 1 light-mounted button, 37-No. 2 light-mounted button, 38-No. 3 light-mounted button, 39-a No. 4 light-mounted button, 40-a No. 5 light-mounted button, 41-No. 6 light-mounted button, 42-No. 7 light-mounted button, 43-No. 8 light-mounted button, 44-parameter display, 45-increase button A, 46-decrease button A, 47-parameter display B, 48-increase button B, 49-decrease button B, 50-No. 11 light-mounted button, 51-No. 12 light-mounted button, 52-No. 13 light-mounted button, 53-No. 14 light-mounted button, 54-No. 15 light-mounted button, 55-No. 16 light-mounted button, 56-No. 17 light-mounted button, 57-No. 18 light-mounted button, 58-pump clutch switch, 59-rotary table clutch switch, 60-cathead selection switch, 61-roller clutch switch, 62-accelerator adjusting knob, and 63-pump stroke adjusting knob.

### DETAILED DESCRIPTION OF THE PREFERRED EMBODIMENT

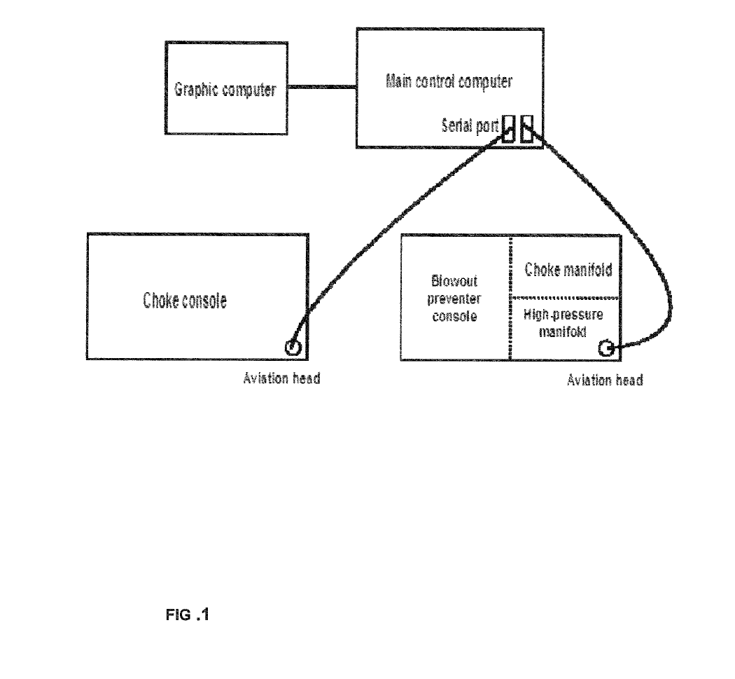

Further description is provided below to the technical disclosure of the invention with reference to the embodiments, but the invention is not limited to the embodiments. As shown in FIG. 1, the portable drilling simulation system comprises a main control computer, a graphic processing computer, a choke console, and a blowout preventer console. The main control computer and the graphic processing computer are interconnected via a local area network. Serial ports of the main control computer are connected with the aviation heads of the choke console and the blowout preventer console via four core cables respectively. The aviation heads are then connected with the internal control plates of the choke console and the blowout preventer console.

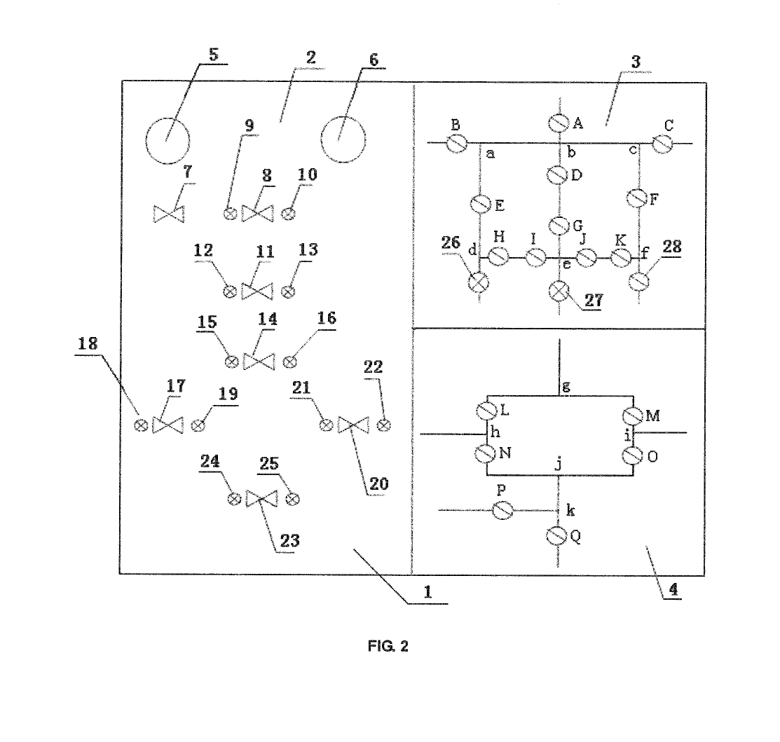

As shown in FIG. 2, the blowout preventer console comprises a chassis and an internal control plate. The front face of the chassis comprises a blowout preventer control panel 1. A blowout preventer control zone 2 is arranged at the left side on the blowout preventer control panel 1. A choke manifold control zone 3 is arranged at the upper part of the right side. A high-pressure manifold control zone 4 is arranged at the lower part of the right side.

The blowout preventer control zone 2 is provided with a ram blowout preventer oil pressure gauge 5, a ring blowout preventer oil pressure gauge 6, a gas source switch 7, a ring switch 8, a ring on indicator 9, a ring off indicator 10, an upper pipe ram switch 11, an upper pipe ram on indicator 12, an upper pipe ram off indicator 13, a blind ram switch 14, a blind ram on indicator 15, a blind ram off indicator 16, a kill manifold switch 17, a kill manifold on indicator 18, a kill manifold off indicator 19, a blowout preventer valve switch 20, a blowout preventer valve off indicator 21, a blowout preventer valve on indicator 22, a lower pipe ram switch 23, a lower pipe ram on indicator 24, and a lower pipe ram off indicator 25.

Crossing points a, b, c, d, e and f are formed by parallel lines and vertical lines on the choke manifold control zone 3 in a ‘+’ crossing connection manner. The flat valve B is arranged on the parallel line at the left end of the crossing point a. The flat valve E is arranged on the vertical line at the left end of the crossing point a. The flat valve A is arranged on the vertical line at the upper end of the crossing point b. The flat valves D and G are sequentially arranged on the vertical line at the lower end of the crossing point b. The flat valve C is arranged on the parallel line at the right end of the crossing point c. The flat valve F is arranged on the vertical line at the lower end of the crossing point b. The flat valves H and I are arranged on the parallel line at the right end of the crossing point d and the parallel line at the left end of the crossing point e. The hydraulic indicator 26 is arranged on the vertical line at the lower end of the crossing point d. The blowout preventer valve switch indicator 27 is arranged on the vertical line at the lower end of the crossing point e. The flat vales are arranged on the parallel line at the right end of the crossing point e and the parallel line at the left end of the crossing point f. The manual throttle valve 28 is arranged on the vertical line at the lower end of the crossing point f.

Crossing points g, h, i, j and k are formed by parallel lines and vertical lines on the high-pressure manifold control zone 4 in a ‘+’ crossing connection manner. The flat valve L is arranged on the vertical line at the upper end of the crossing point h. The flat valve N is arranged on the vertical line at the lower end of the crossing point h. The flat valve M is arranged on the vertical line at the upper end of the crossing point i. The flat valve O is arranged on the vertical line at the lower end of the crossing point i. The flat valve P is arranged on the parallel line at the left end of the crossing point K. The flat valve Q is arranged on the vertical line at the lower end of the crossing point k.

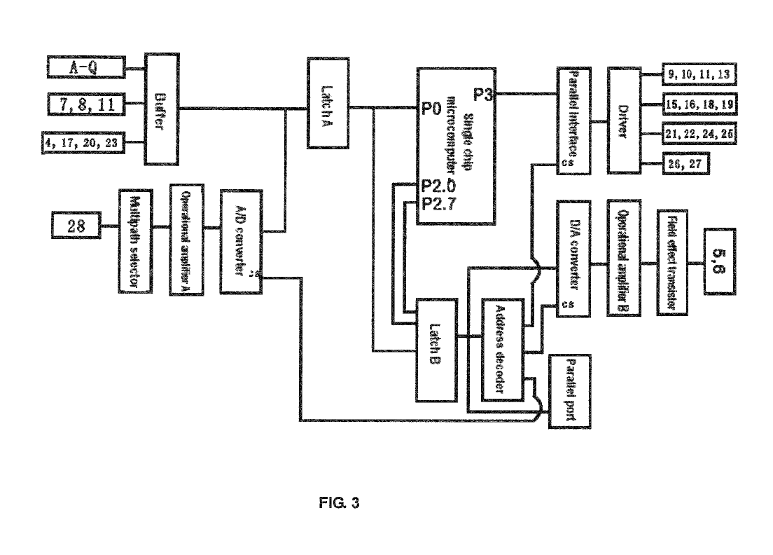

As shown in FIG. 3, the internal control plate of the blowout preventer console comprises a single chip microcomputer and a peripheral circuit. The gas source switch 7, the ring switch 8, the upper pipe ram switch 11, the blind ram switch 14, the kill manifold switch 17, the blowout preventer valve switch 20, the lower pipe ram switch 23, and flat plates A to Q are connected to the latch via the buffer. The output of the latch A is connected with one data input/output port PO of the single chip microcomputer. The manual throttle valve 28 is connected with a multipath selector. The output of the multipath selector is connected with an operational amplifier. The output of the operational amplifier is connected to the latch A via an AD converter. The output of the latch A is connected with one data input/output port PO of the single chip microcomputer. The input/output port PO of the single chip microcomputer also serves as a data output port. The output of the input/output port is connected with the latch B. The output of the latch B is connected with the DA convertor. The output of the DA converter is connected with an operational amplifier B. The output of the operational amplifier B is connected with the field effect transistor. The output of the field effect transistor is connected with the ram blowout preventer oil pressure gauge 5 and the ring blowout preventer oil pressure gauge 6 respectively. Another data input/output port P3 of the single chip microcomputer is connected with the parallel interface. The parallel interface is connected with the driver. The output of the driver is connected with the ring on indicator 9, the ring off indicator 10, the upper pipe ram on indicator 12, the upper pipe ram off indicator 13, the blind ram on indicator 15, the blind ram off indicator 16, the kill manifold on indicator 18, the kill manifold off indicator 19, the blowout preventer valve off indicator 21, the blowout preventer valve on indicator 22, the lower pipe ram on indicator 24, the lower pipe ram off indicator 25, the hydraulic indicator 26, and the blowout preventer valve switch indicator 27. Two outputs of the third input/output port P2 of the single chip microcomputer are connected with an address decoder via the latch B. The decoding output of the address decoder is connected with the parallel interface, and the selection control ends of the DA converter and the AD converter respectively.

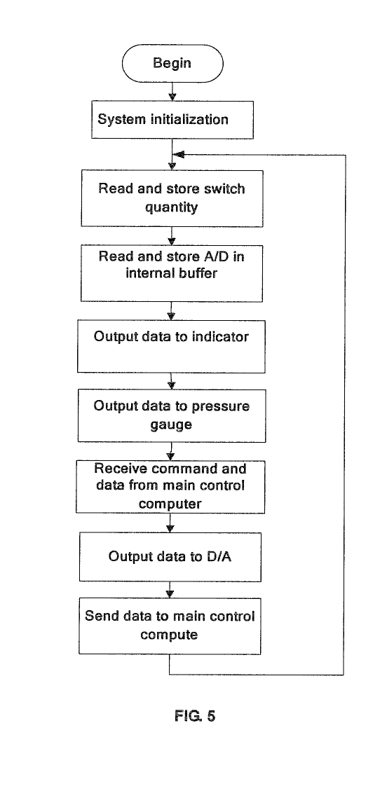

FIG. 5 is a flow chart of the main control program of the blowout preventer console. Its control flow is as follows. A control program is initiated. An initialization program completes the initialization of ports on the internal control plate, such as serial ports and parallel ports, in order to realize point-to-point communication with a remote console, and also completes the initial value setting of the indicators on the panel and relevant parameters. Then, switch quantity is read and stored in an internal buffer so that switch states are sent from the serial ports to a main control computer. An A/D result is then read and stored in the internal buffer so that an A/D-converted value is sent from the serial ports to the main control computer. Afterwards, data are output to the indicators to control the display of the indicators based on the switch states. Data are output to the pressure gauge for displaying initial values. The ram blowout preventer oil pressure gauge and the ring blowout preventer oil pressure gauge display the values of initial state. Then, a command and data from the main control computer are received. The single chip microcomputer receives the command and data from the main control computer in an interruption manner. The interruption process is to read the value of the serial port SBuf of the single chip microcomputer. The command sent from the main control computer is received if SBuf=1 is true, then return from interruption is performed. Data are output to D/A for controlling the display of the ram blowout preventer oil pressure gauge and the ring blowout preventer oil pressure gauge. Finally, the single chip microcomputer sends the data to the main control computer in an interruption manner, and the above steps are cycled.

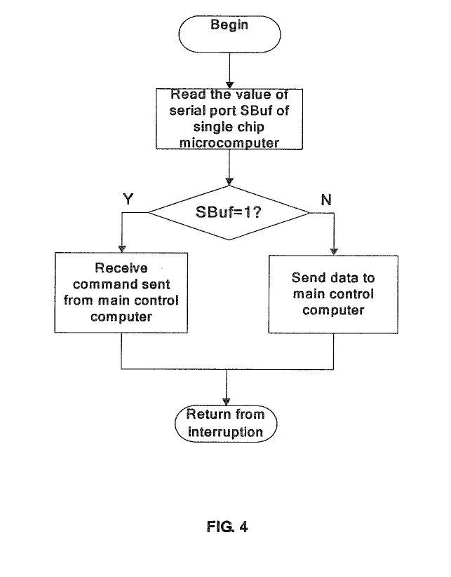

FIG. 4 is a flow chart of the interruption manner of the blowout preventer console. When the interruption process is started, the value of the serial port SBuf of the single chip microcomputer is read first. If SBuf=1 is true, the single chip microcomputer receives the command sent from the main control computer and then return from interruption is performed, the single chip microcomputer sends the data to the main control computer. If SBuf=1 is false, then return from interruption is performed.

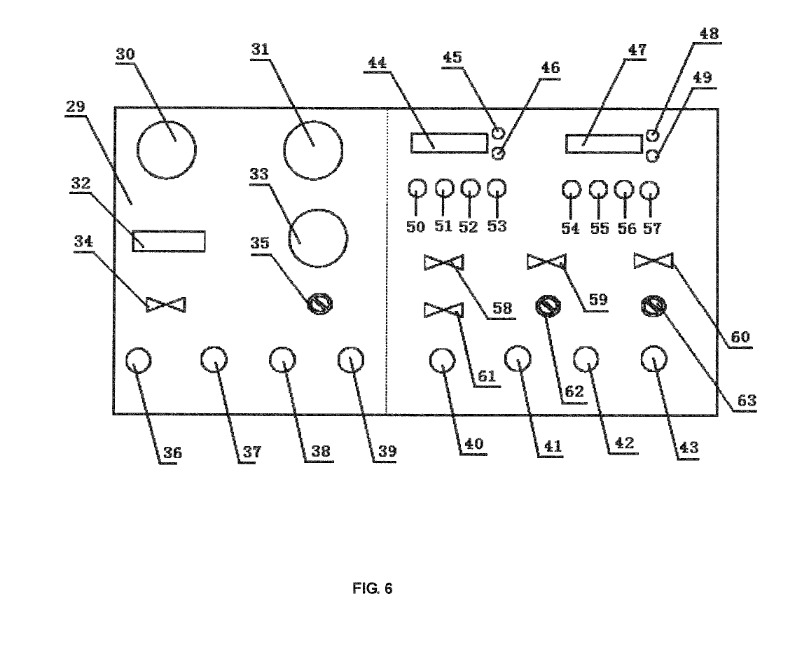

As shown in FIG. 6, the choke console comprises a chassis and an internal control circuit board. The front face of the chassis comprises a choke control panel 29. The choke control panel 29 is provided with a vertical pipe pressure gauge 30, a sleeve pressure gauge 31, a throttle valve opening gauge 33, a display set, a knob set, a switch set, and a light-mounted button set, wherein the display set comprises a pump stroke display 32, a parameter display A 44 and a parameter display B 47. The knob set comprises a throttle valve speed-adjusting knob 35, an increase button A 45, a decrease button A 46, an increase button B 48, a decrease button B 49, an accelerator adjusting knob 62, and a pump stroke adjusting knob 63. The switch set comprises a throttle regulating vale switch 34, a pump clutch switch 58, a rotary table clutch switch 59, a cathead selection switch 60, and a roller clutch switch 61. The light-mounted button set comprises a No. 1 light-mounted button 36, a No. 2 light-mounted button 37, a No. 3 light-mounted button 38, a No. 4 light-mounted button 39, a No. 5 light-mounted button 40, a No. 6 light-mounted button 41, a No. 7 light-mounted button 42, a No. 8 light-mounted button 43, a No. 11 light-mounted button 50, a No. 12 light-mounted button 51, a No. 13 light-mounted button 52, a No. 14 light-mounted button 53, a No. 15 light-mounted button 54, a No. 16 light-mounted button 55, a No. 17 light-mounted button 56, and a No. 18 light-mounted button 57.

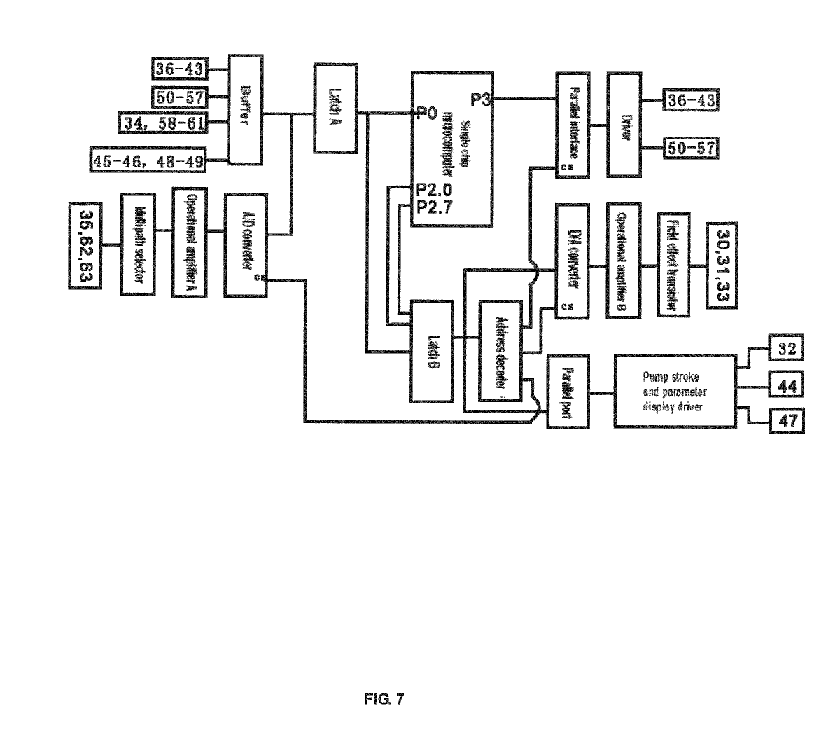

As shown in FIG. 7, the internal control circuit plate of the choke console comprises a single chip microcomputer and a peripheral circuit thereof. Twenty five switch quantity inputs including the light-mounted button set, the switch set, the increase button A45, the decrease button A46, the increase button B48, and the decrease button B49 are connected with the buffer. The output of the buffer is connected with the latch A. The output of the latch A is connected to one data input/output port PO of the single chip microcomputer. Three analog quantities, i.e. the throttle valve speed-adjusting knob 35, the accelerator adjusting knob 62 and the pump stroke adjusting knob 63, are connected with the multipath selector. The output of the multipath selector is connected with the operational amplifier A. The output of the operational amplifier A is connected with the AD converter. The output of the AD converter is connected with the latch A. The input/output port P0 of the single chip microcomputer also serves as a data output port. The output of the data output port is connected with the latch B. The output of the latch B is divided into two paths one of which is connected with the DA converter. The output of the DA converter is connected with the operational amplifier B. The output of the operational amplifier B is connected with the field effect transistor. The output of the field effect transistor is connected with the vertical pipe pressure gauge 30, the sleeve pressure gauge 31 and the throttle valve opening gauge 33. The other path of the output of the latch B is connected with a parallel port. The output of the parallel port is connected with a pump stroke and parameter display driver. The output of the pump stroke and parameter display driver is connected with the pump stroke display 32, the parameter display A44 and the parameter display B47. Another data input/output port of the single chip microcomputer is connected with the parallel interface. The parallel interface is connected with a driver. The output of the driver is connected with the light-mounted button set. Two outputs of the third input/output port P3 of the single chip microcomputer are connected with the address decoder via the latch B. The output of the address decoder is connected with the parallel interface, and the selection control ends of the DA converter and the AD converter respectively.

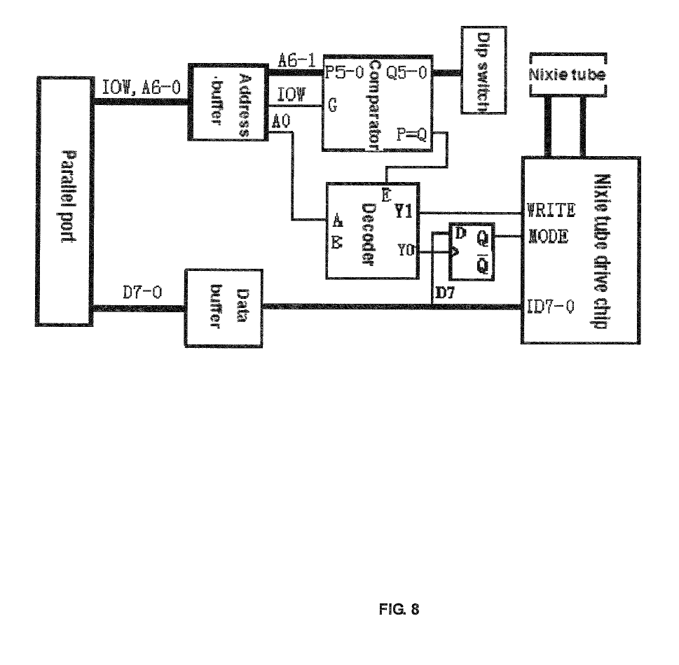

As shown in FIG. 8, the pump stroke and parameter display driver comprises an address buffer, a data buffer, a comparator, a decoder, a dip switch, a nixie tube drive chip, and a nixie tube. The input ends of the address buffer and the data buffer are both connected with the parallel port. The output of the data buffer is connected with the nixie tube drive chip. The output of the nixie tube drive chip is connected with the nixie tubes of the pump stroke display 32, the parameter display A44 and the parameter display B47 respectively. The output of the address buffer is connected with the comparator and the decoder respectively. The other input end of the comparator is connected with the dip switch. The output of the comparator is connected with the enabling end of the decoder. One output end of the decoder is connected with the writing control end of the nixie tube drive chip, and the other output end of the decoder is connected with the mode control end of the nixie tube drive chip via a trigger.

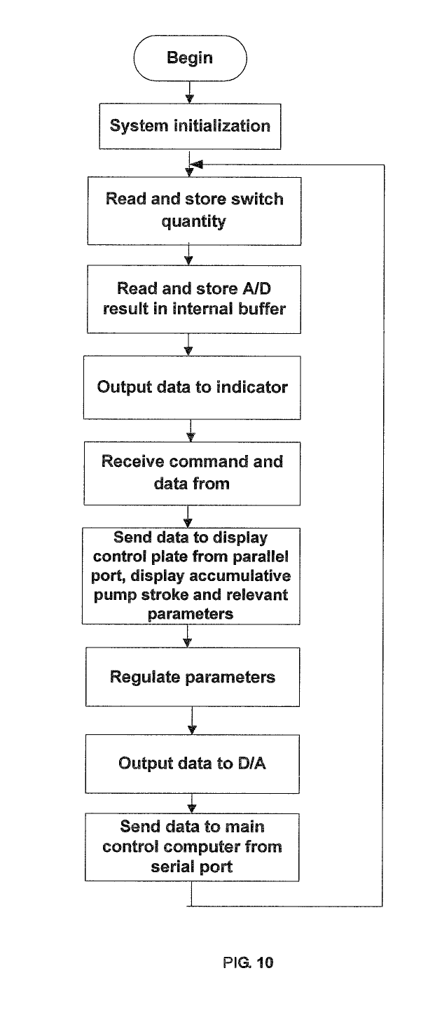

FIG. 10 is a working flow chart of the main control program of the choke console. Its working flow is as follows. The initialization of ports on the internal control plate, such as serial ports and parallel ports. The initial value setting of the indicators on the panel and relevant parameters are completed in system initialization. Then, switch quantity is read and stored in an internal buffer so that switch states are sent from the serial ports to a main control computer. An A/D result is then read and stored in the internal buffer so that an A/D-converted value is sent from the serial ports to the main control computer. Afterwards, data are output to the indicators. The single chip microcomputer receives the command and data from the main control computer in an interruption manner and then send the data from the parallel ports to a display control plate for displaying accumulative pump stroke, mud density, heavy mud volume, and other relevant parameter values, for example discordance of parameters with operating requirements and increase or decrease of parameter values. Then, data are output to D/A for controlling the display of instruments for vertical tube pressure, sleeve pressure, throttle valve opening, and the like. Afterwards, the single chip microcomputer sends the data to the main control computer in an interruption manner. Finally, return is performed, and the above steps are cycled.

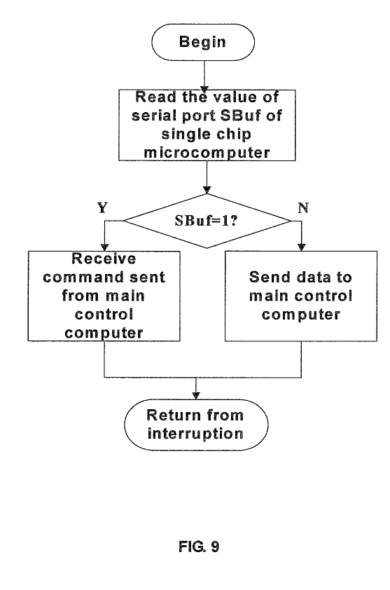

FIG. 9 is a flow chart of the choke console receiving the command and sending the data in an interruption manner. Its flow is as follows: the value of the serial port SBuf of the single chip microcomputer is read. Data are sent to the main control computer if SBuf=1. Otherwise, the command sent from the main control computer is received. Then, return from interruption is performed.

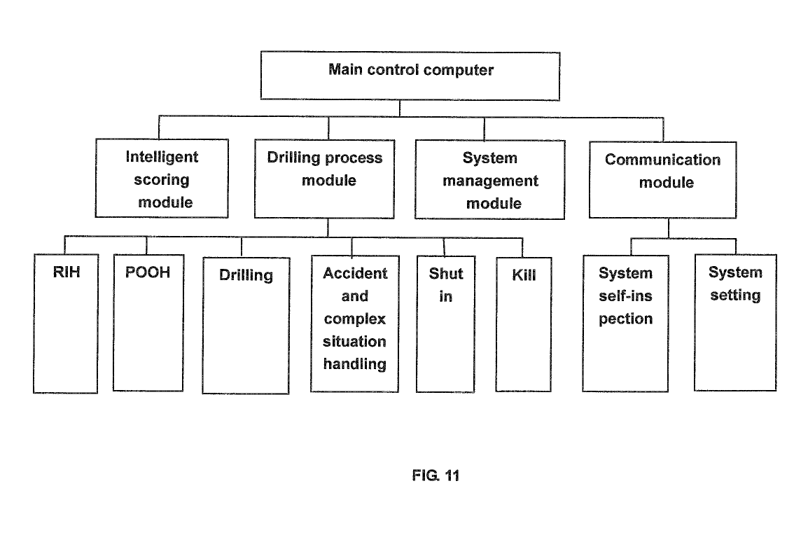

As shown in FIG. 11, the main control computer comprises a portable computer and a main control program running thereon. The main control program comprises a drilling process module, a system management module, an intelligent scoring module, and a communication module. The main control program is communicated with front end hardware equipment (the blowout preventer console and the choke console) via the communication module to obtain the state of the hardware equipment in real-time, for example parameters such as rotation number of rotary table, brake state, mud discharging quantity and mud density, needed to be obtained in the simulation for drilling process, and then a typical drilling process is simulated by means of relevant mathematical models to finish the following tasks: 1, A control command is sent to the graphic processing program via TCP/IP protocol, and thus the graphic processing program can be driven to generate an animation process that is synchronous with the operation of the hardware equipment. 2. An intelligent scoring system is realized. 3. A signal is fed back to the front end hardware, enabling the parameter display of front end instruments to accord with onsite situation.

The system management module comprises a system self-inspection and system setting sub-module, function check for the choke console, and the blowout preventer console. Choke manifolds and high-pressure manifolds thereof are completed mainly in system self-inspection in order to determine whether the front end equipment operates normally. The specific method is as follows: the state of various switches, buttons or valves of the front end hardware equipment is changed so that synchronous change can be seen in the main control program. In this case, whether the front end equipment operates normally can be observed. System setting is used for correcting major components of the front end hardware equipment, mainly including brake correction, foot accelerator correction, needle valve correction, hand accelerator 1 correction, hand accelerator 2 correction, hand accelerator 3 correction, throttling speed correction, system operation setting, and etc . . . .

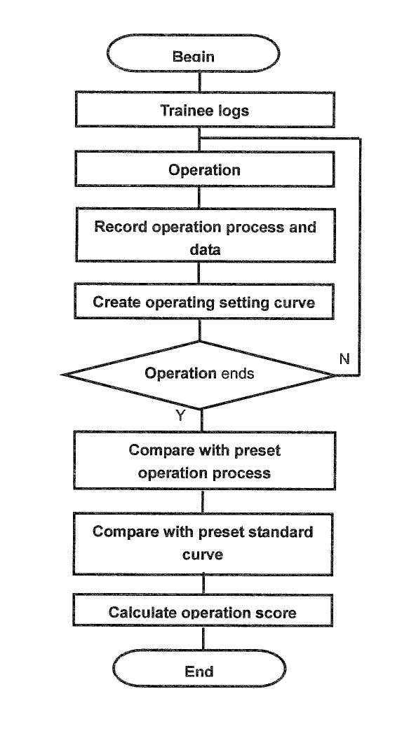

As shown in FIG. 12, the intelligent scoring module is mainly used for automatically scoring the training process. Scoring is related mainly to two factors. 1. Operating flow: all the operating flows of trainees are recorded in the system, wherein the operating flow of trainee is compared with a preset operating flow in the system upon the completion of trainee examination to evaluate the accordance of the two flows and score the operating flow of trainees on this basis. 2. Operating level: in addition to the grasp of corrective operating flow by trainees, their operating flows shall be taken into consideration in comprehensively evaluating the technical level of trainees, e.g. whether the selection for weight on bit during drilling in is appropriate and whether drilling is even; for the problem whether the control for pressure during killing meets the demand of killing constructor, the system determines the operating level score by adopting a method for recording relevant data curves in the operating flow and comparing the data curves with standard curves afterwards. The scoring process is as follows: a trainee logs in the system, begins examination and completes corresponding operations, and the system scores automatically based upon relevant standards to obtain a final score.

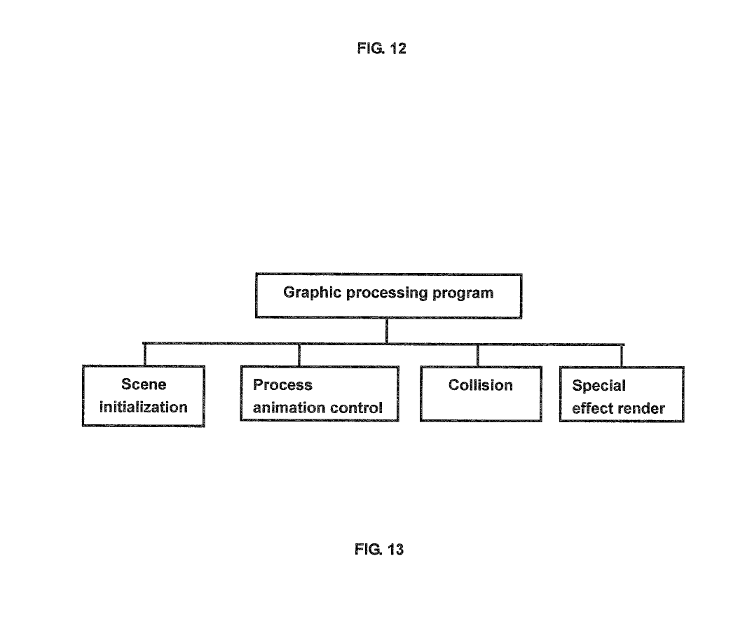

As shown in FIG. 13, the graphic computer comprises a portable computer and a graphic processing program running thereon. The graphic processing program comprises a scene initialization module, a process animation control module, a collision processing module, and a render effect module. A vivid, virtual drilling environment is created by means of full three-dimensional animation so that trainees feel as if they were in a real drilling environment. Thus, the mental resilience of trainees in accident handling is improved and better training effect is obtained. The four modules have the following functions:

Scene initialization: the current scene of every operation differs owing to the complexity of drilling process and the operability of virtual training. Before a new operation begins, the graphic program initializes the current scene after receiving an operation command sent from the control computer, for example the current number, state and position of operating components on a drilling platform.

Process animation control: in the process of completing the specified process operation, every action from drilling console is converted into a digital signal. The digital signal is transmitted to the main control computer. Protocol data are then sent to the graphic program by the main control computer. The graphic program gives a specific response after the acquisition of parameters. Motion parameters, specific motions and view selection (including aboveground visual angle, underground visual angle, blowout preventer visual angle, multi-view display, etc.) of various control systems on drilling platform are reflected on a graphic machine.

Collision processing: the situation of ‘wall through’ is not allowed in the motion simulation process of three-dimensional graphics. Therefore, collision detection shall be performed on motion objects. To cause model motion to be realistic, a drilling simulator visual simulating system certainly includes collision detecting and processing parts.

Render effect: simulation for flame, bubble, liquid jetting effects is realized. Movie-level illumination effect is accomplished using GLSL. Illumination modes like daylight, night and searchlight can be simulated respectively, thus greatly improving graphic effect and sense of reality.

The drilling process module comprises an RIH sub-module, a POOH sub-module, a drill-in sub-module, an accident and complex situation handling sub-module, a shut in sub-module, and a killing sub-module. It is the most important module in the main control program. Event drive training has no limitation to trainees, who therefore can operate the simulator randomly. The graphic system will reflect reasonable mechanical motions and simultaneously give a voice prompt with regard to erroneous operations. The module is mainly used for cognitive training of new trainees about drilling site and drilling machinery. In technical process training, trainees are required to operate the simulator per its technical process, in order to intensify the comprehension of trainees on the technical process and make trainees master the operation process of the simulator.

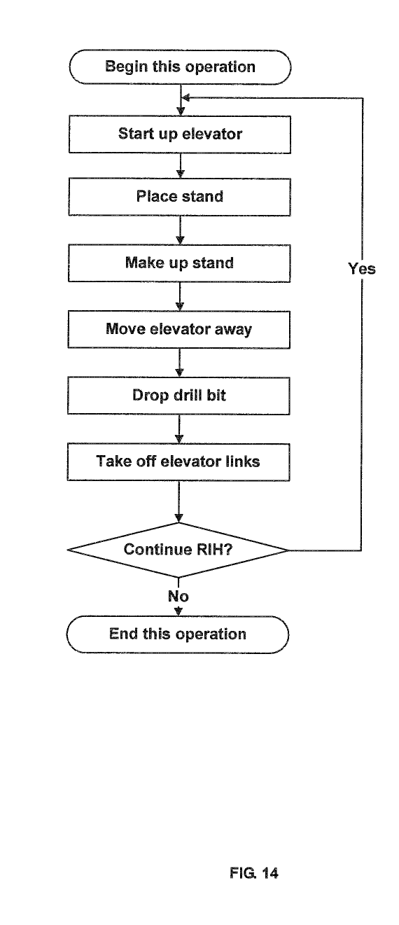

FIG. 14 is a flow chart of normal RIH, wherein its working flow is approximately as follows: begin this operation, start up an elevator, then place and make up stand, move the elevator away, drop a drill bit, take off elevator links, judge whether RIH is performed, if so, return to start up the elevator, otherwise, end this operation.

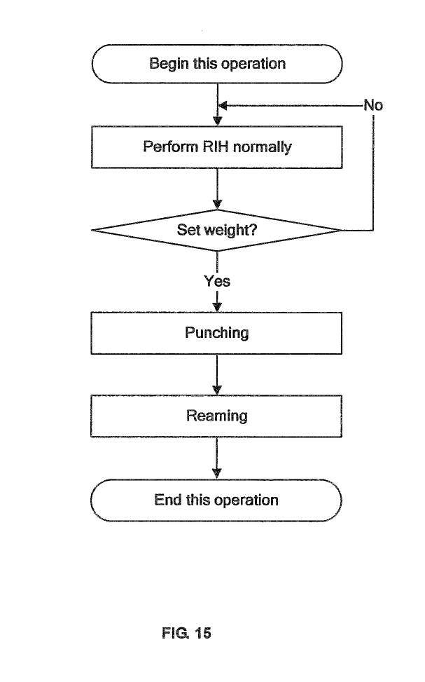

FIG. 15 is a flow chart of set weight, wherein its working flow is approximately as follows: begin this operation, perform RIH normally, perform punching and reaming in the event of set weight, end this operation, and return if set weight does not occur.

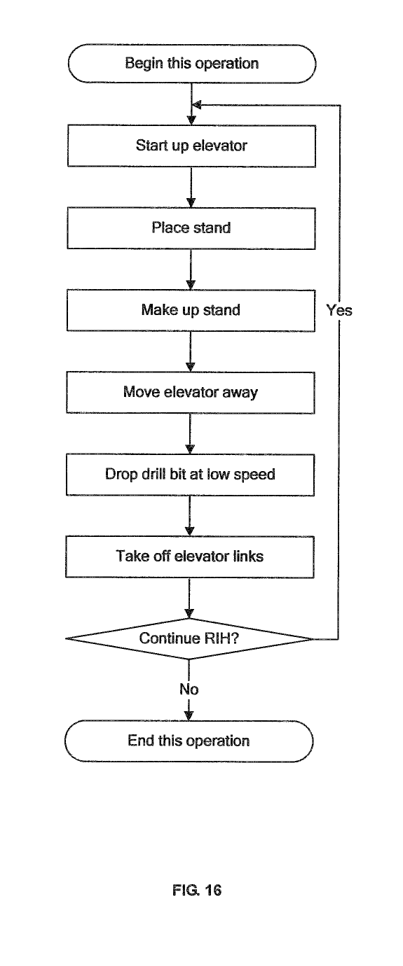

FIG. 16 is a flow chart of fluctuation pressure controlling RIH, wherein its working flow is approximately as follows: begin this operation, start up an elevator, then place and make up stand, move the elevator away, drop a drill bit at low speed, press corresponding button to take off elevator links, judge whether RIH is continued, if so, return to begin this operation, otherwise, end this operation.

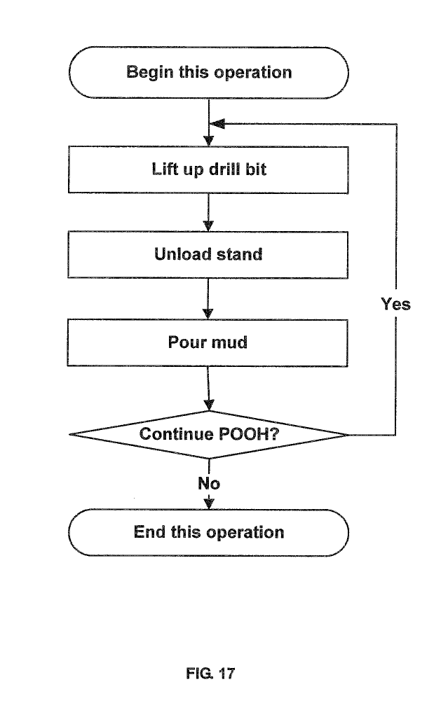

FIG. 17 is a flow chart of normal POOH, wherein its working flow is approximately as follows: begin this operation, lift up a drill bit, unload a stand, pour mud, judge whether POOH is performed, if so, return to begin this operation, otherwise, end this operation.

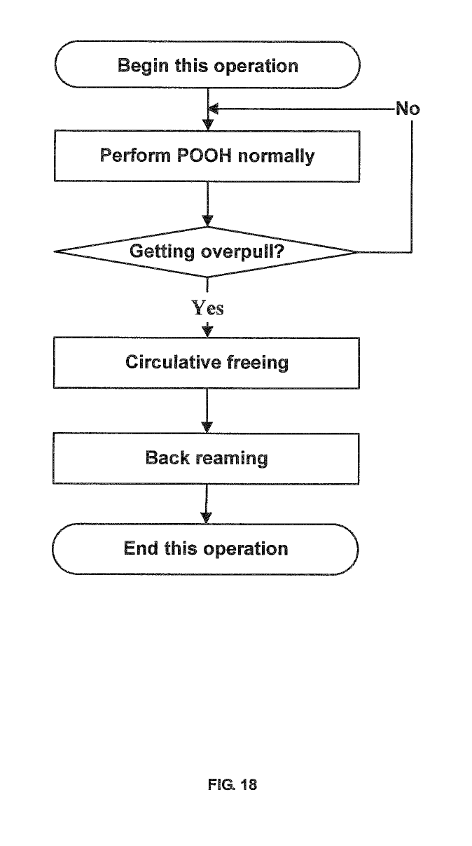

FIG. 18 is a flow chart of getting overpull, wherein its working flow is approximately as follows: begin this operation, perform POOH normally, perform circulative freeing in the event of getting overpull, perform back reaming, end this operation, and return to normal POOH in the case of being unstuck.

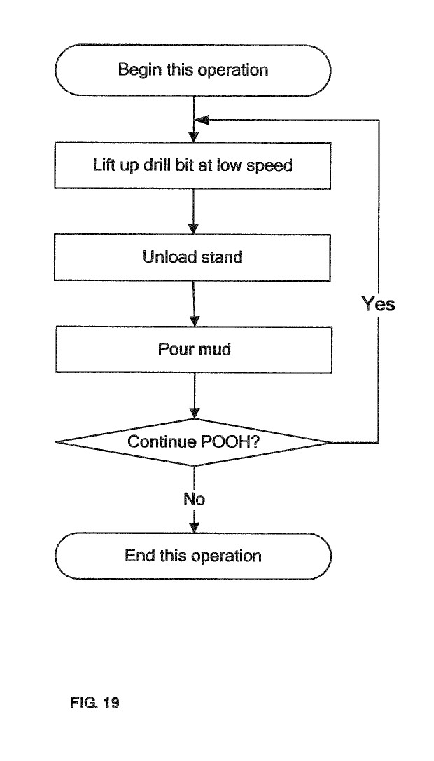

FIG. 19 is a flow chart of suction pressure controlling POOH, wherein its working flow is approximately as follows: begin this operation, lift the drill bit at low speed, unload the stand, pour the mud, judge whether POOH is continued, if so, return to lift the drill bit at low speed, otherwise, end this operation.

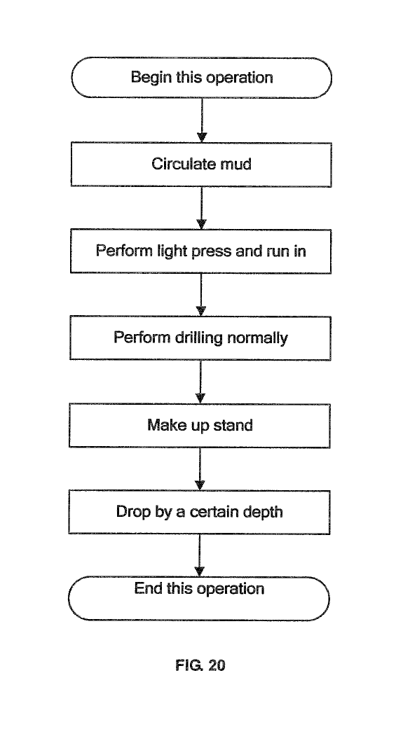

FIG. 20 is a flow chart of normal drilling and stand makeup, wherein its working flow is approximately as follows: begin this operation, circulate mud, perform light press and running in, perform drilling normally, make up the stand, and drop by a certain depth to end this operation.

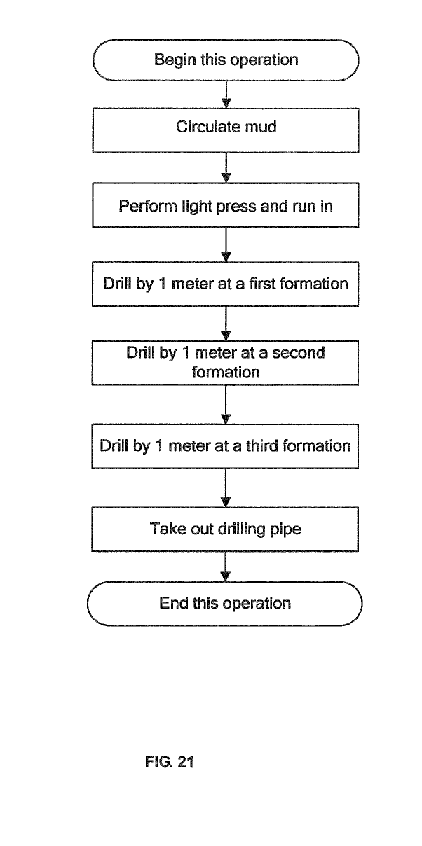

FIG. 21 is a flow chart of drilling under different formation drillabilitie, wherein its working flow is approximately as follows: begin this operation, circulate mud, perform light press and running in, drill by 1 meter at a first formation, drill by 1 meter at a second formation, drill by 1 meter at a third formation, take out drilling pipe, and end this operation.

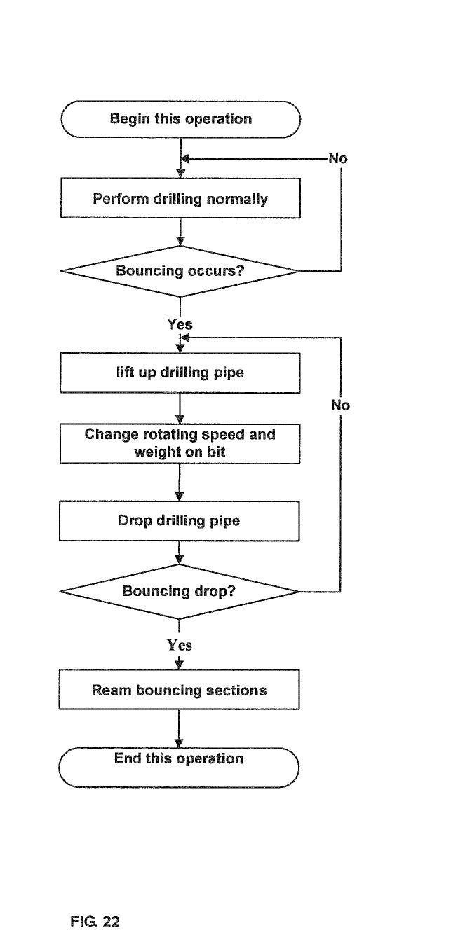

FIG. 22 is a flow chart of drilling under bouncing, wherein its working flow is approximately as follows: begin this operation, perform drilling normally if not bouncing occurs, lift up drilling pipe if bouncing occurs, change rotating speed and weight on bit, drop drilling pipe, judge whether bouncing is reduced, return to lift up drilling pipe if bouncing is not reduced, circulate the operation until bouncing is reduced, then ream bouncing sections, and end this operation.

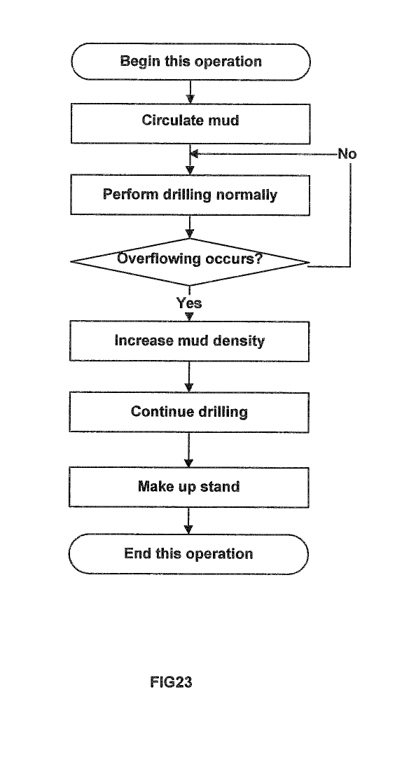

FIG. 23 is a flow chart of high-pressure formation drilling, wherein its working flow is approximately as follows: begin this operation, circulate mud, perform drilling normally, judge whether overflowing occurs, perform drilling normally if not overflowing occurs, otherwise, increase mud density, continue drilling, make up the stand, and finally, end this operation.

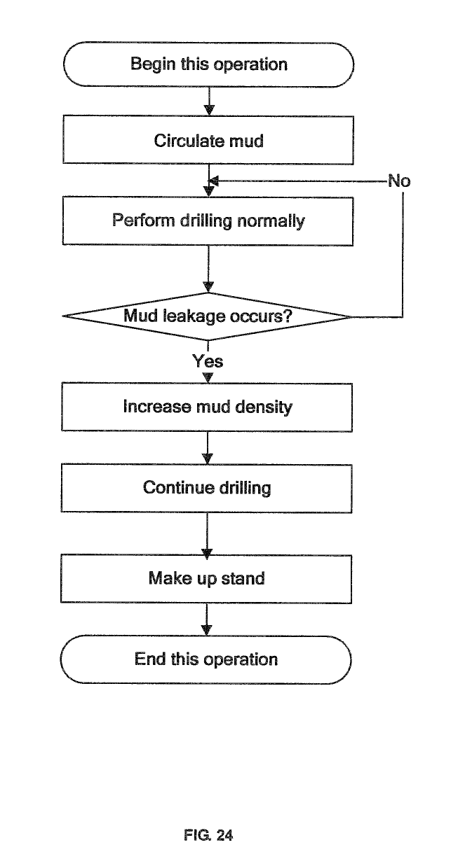

FIG. 24 is a flow chart of low-pressure formation drilling, wherein its working flow is approximately as follows: begin this operation, circulate mud, perform drilling normally, judge whether leakage occurs, perform drilling normally if not leakage occurs, otherwise, increase mud density, continue drilling, make up the stand, and finally, end this operation.

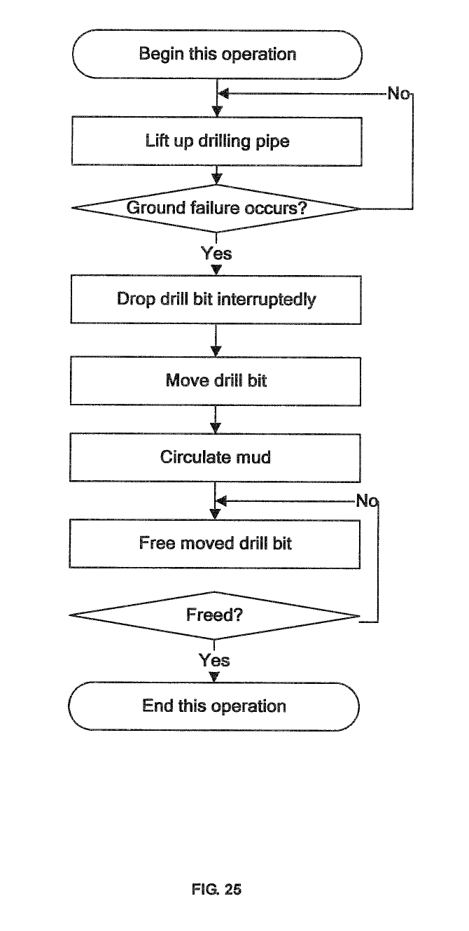

FIG. 25 is a flow chart of adhesion sticking judging and handling, wherein its working flow is approximately as follows: begin this operation, lift up the drilling pipe, judge whether there is a ground failure, continue lifting up the drilling pipe if there is no failure, drop the drill bit interruptedly if there is a failure, move the drill bit, circulate mud, free the moved drill bit, then judge whether the moved drill bit has been freed, if not, return to continue freeing until freeing is completed, and end this operation.

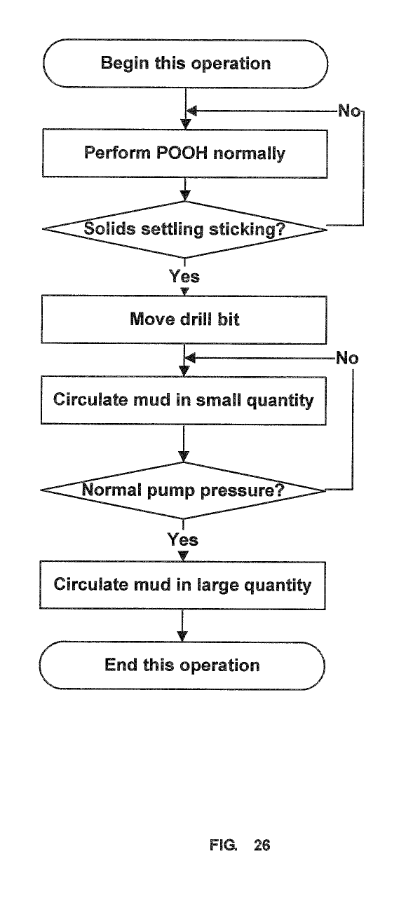

FIG. 26 is a flow chart of solids settling sticking judging and handling, wherein its working flow is approximately as follows: begin this operation, perform POOH normally, judge whether there is solids settling sticking, if not, return to normal POOH, move the drill bit if there is solids settling sticking, circulate mud in small quantity, judge whether pump pressure is normal, if not, return to circulate mud, if so, circulate mud in large quantity, and finally, end this operation.

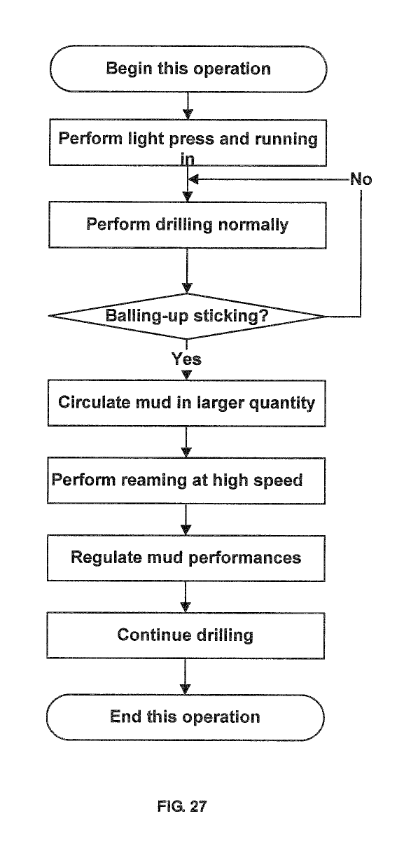

FIG. 27 is a flow chart of balling-up sticking judging and handling, wherein its working flow is approximately as follows: begin this operation, perform light press and running in, perform drilling, judge whether there is balling-up sticking, if not, return to normal POOH, if so, circulate mud in larger quantity, perform reaming at high speed, regulate mud performances, continue drilling, and finally, end this operation.

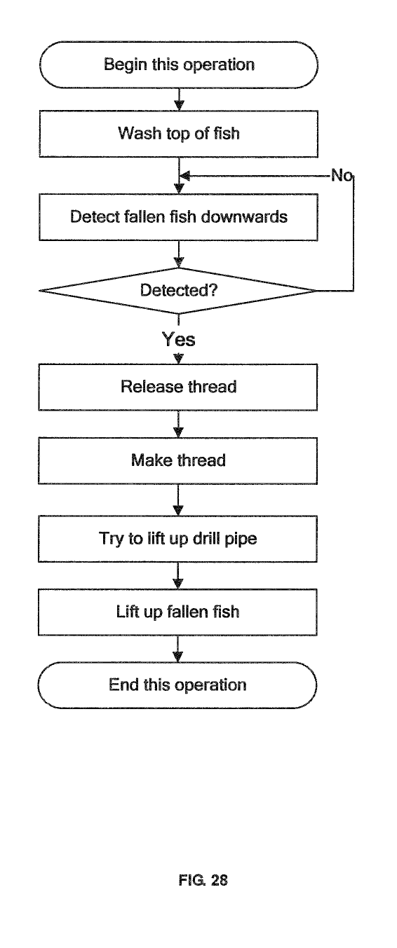

FIG. 28 is a flow chart of taper tap fishing, wherein its working flow is approximately as follows: begin this operation, wash top of fish, detect fallen fish downwards, judge whether the fallen fish is detected, if not, return to continue downward detection, if so, release thread, make thread, try to lift up the drill pipe, lift up the fallen fish, and finally, end this operation.

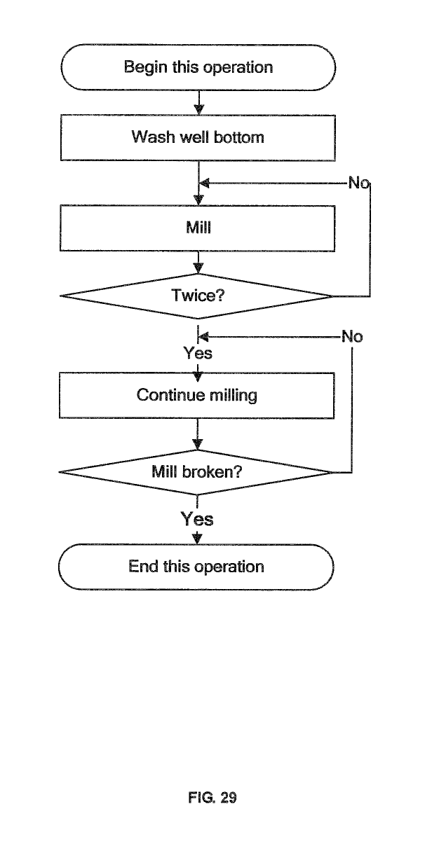

FIG. 29 is a flow chart of junk milling, wherein its working flow is approximately as follows: begin this operation, wash well bottom, mill twice, continue milling until the mill is broken, and end this operation.

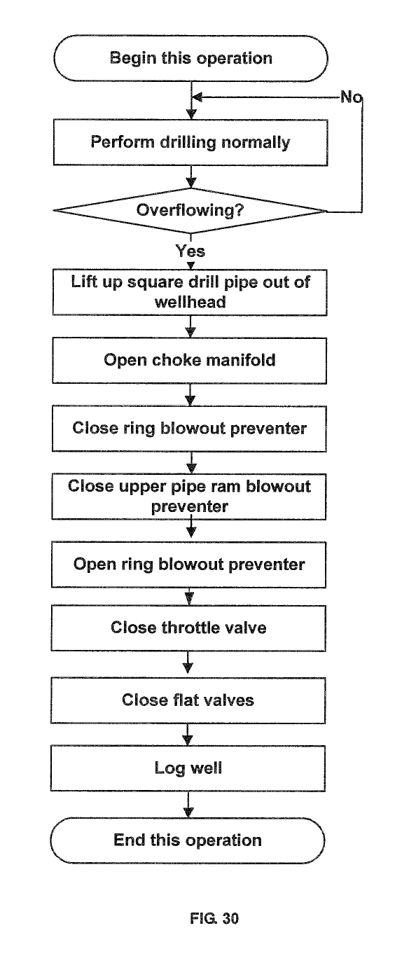

FIG. 30 is a flow chart of normal drilling and shutting in, wherein its working flow is approximately as follows: begin this operation, perform drilling normally, judge whether overflowing occurs, if not, perform drilling normally, if so, open the choke manifold and close ring blowout preventer, upper pipe ram blowout preventer, throttle valve and J2A flat valves, then log well and end this operation.

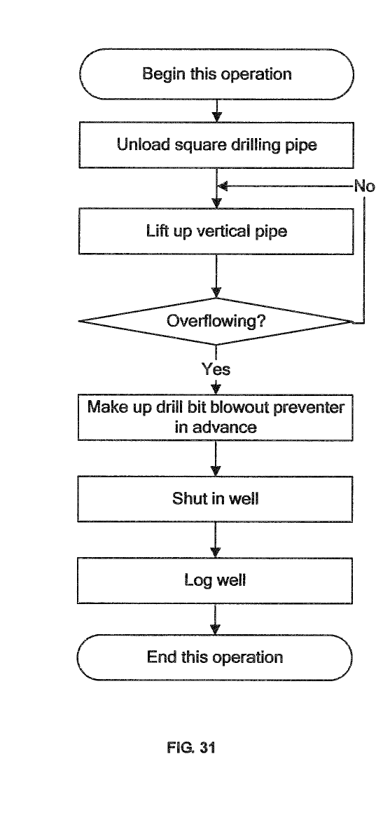

FIG. 31 is a flow chart of POOH and shutting in, wherein its working flow is approximately as follows: begin this operation, unload a square drilling pipe, lift up a vertical pipe, judge whether overflowing occurs, if not, return to lift up the vertical pipe, if so, make up a drill bit blowout preventer in advance, shut in well, log well, and end this operation.

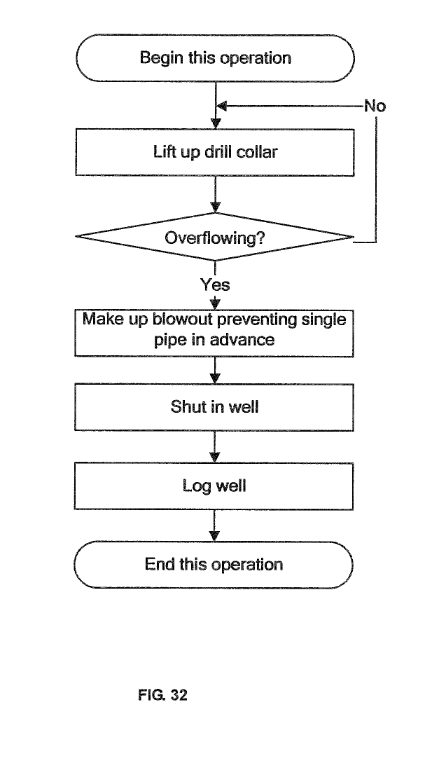

FIG. 32 is a flow chart of drill collar lifting and shutting in, wherein its working flow is approximately as follows: begin this operation, lift up a drill collar, judge whether overflowing occurs, if not, return to lift up the drill collar, if so, make up a blowout preventing single pipe in advance, shut in well, log well, and end this operation.

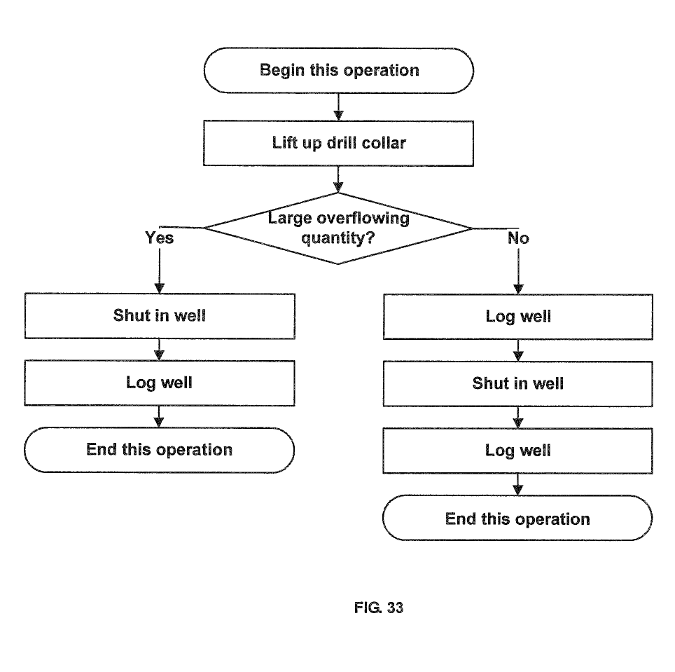

FIG. 33 is a flow chart of emptying and shutting in, wherein its working flow is approximately as follows: begin this operation, judge whether the overflowing quantity is large after the drill collar is lifted up, if so, shut in well, log well and finally end this operation; if not, make up the blowout preventing single pipe in advance, shut in well, log well, and finally end this operation.

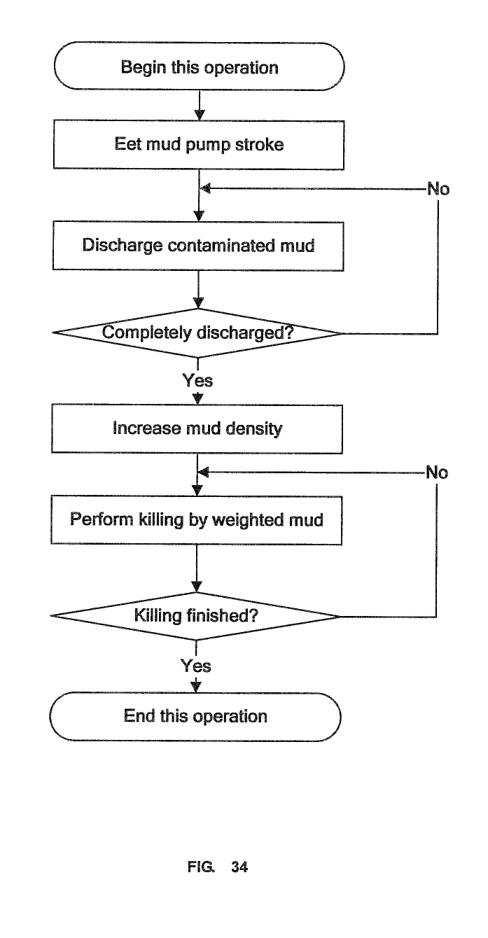

FIG. 34 is a flow chart of killing by driller's method, wherein its working flow is approximately as follows: begin this operation, set mud pump stroke, discharge contaminated mud, judge whether the contaminated mud is completely discharged, if not, return to discharge the contaminated mud completely, if so, increase mud density, perform killing by weighted mud, judge whether killing is finished, if not, return to continue killing, if so, end this operation.

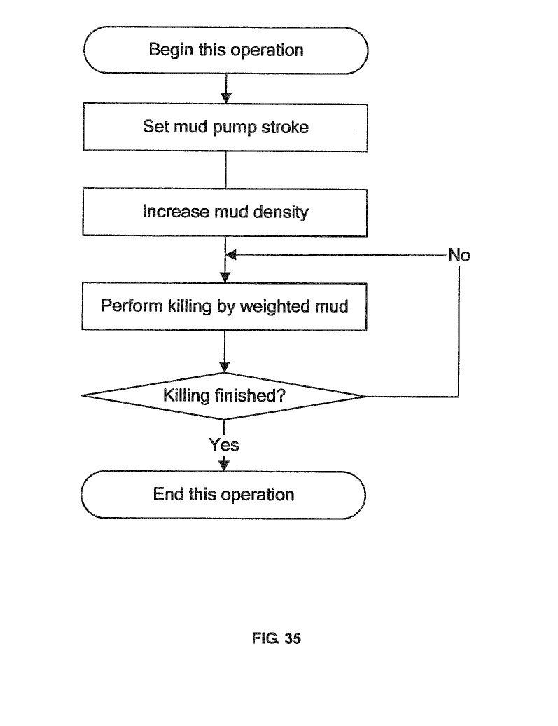

FIG. 35 is a flow chart of killing by engineer's method, wherein its working flow is approximately as follows: begin this operation, set mud pump stroke, increase mud density, then perform killing by weighted mud, judge whether killing is finished, if not, return to continue killing, if so, end this operation.

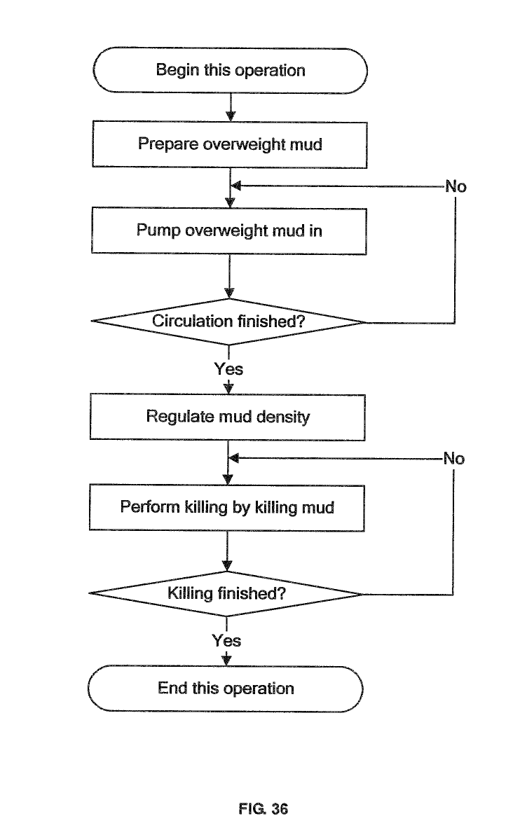

FIG. 36 is a flow chart of killing by overweight mud driller's method, wherein its working flow is approximately as follows: begin this operation, prepare overweight mud, pump the overweight mud in, judge whether circulation is finished, if so, regulate mud density, perform killing by killing mud, and judge whether killing is finished, if not, return to continue killing, if so, end this operation.

One skilled in the art will understand that the embodiment of the present invention as shown in the drawings and described above is exemplary only and not intended to be limiting.

It will thus be seen that the objects of the present invention have been fully and effectively accomplished. It embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A portable drilling simulation system, comprising: a main control computer, a graphic processing computer, a choke console, and a blowout preventer console, the main control computer and the graphic processing computer being interconnected via a local area network, the main control computer being connected with the choke console and the blowout preventer console via serial ports respectively;
the blowout preventer console comprising a chassis and an internal control plate, the front face of the chassis comprising a blowout preventer control panel, a blowout preventer control zone being arranged at a left side on the blowout preventer control panel, a choke manifold control zone being arranged at an upper part of the right side, a high-pressure manifold control zone being arranged at a lower part of the right side;
the blowout preventer control zone being provided with a ram blowout preventer oil pressure gauge, a ring blowout preventer oil pressure gauge, a gas source switch, a ring switch, a ring on indicator, a ring off indicator, an upper pipe ram switch, an upper pipe ram on indicator, an upper pipe ram off indicator, a blind ram switch, a blind ram on indicator, a blind ram off indicator, a kill manifold switch, a kill manifold on indicator, a kill manifold off indicator, a blowout preventer valve switch, a blowout preventer valve off indicator, a blowout preventer valve on indicator, a lower pipe ram switch, a lower pipe ram on indicator and a lower pipe ram off indicator;
the internal control plate of the blowout preventer console comprising a single chip microcomputer and a peripheral circuit, the gas source switch, the ring switch, the upper pipe ram switch, the blind ram switch, the kill manifold switch, the blowout preventer valve switch, the lower pipe ram switch, and flat plates A to Q being connected to a first latch via a buffer, the output of the first latch being connected with one data input/output port of the single chip microcomputer, a manual throttle valve being connected with a multipath selector, the output of the multipath selector being connected with an operational amplifier, the output of the operational amplifier being connected to the first latch via an AD converter, the output of the first latch being connected with one data input/output port of the single chip microcomputer, the input/output port also serving as a data output port, the output of the input/output port being connected with a second latch, the output of the second latch being connected with a DA convertor, the output of the DA converter being connected with an operational amplifier, the output of the operational amplifier being connected with a field effect transistor, the output of the field effect transistor being connected with the ram blowout preventer oil pressure gauge and the ring blowout preventer oil pressure gauge respectively, another data input/output port of the single chip microcomputer being connected with a parallel interface, the parallel interface being connected with a driver, the output of the driver being connected with the ring on indicator, the ring off indicator, the upper pipe ram on indicator, the upper pipe ram off indicator, the blind ram on indicator, the blind ram off indicator, the kill manifold on indicator, the kill manifold off indicator, the blowout preventer valve off indicator, the lower pipe ram on indicator, the lower pipe ram off indicator, a hydraulic indicator and a blowout preventer valve switch indicator; two outputs of the third input/output port of the single chip microcomputer being connected with an address decoder via the second latch, the decoding output of the address decoder being connected with the parallel interface, and the selection control ends of the DA converter and the AD converter respectively;
crossing points a, b, c, d, e and f being formed by parallel lines and vertical lines on the choke manifold control zone in a ‘+’ crossing connection manner, the flat valve B being arranged on the parallel line at the left end of the crossing point a, the flat valve E being arranged on the vertical line at the left end of the crossing point a, the flat valve A being arranged on the vertical line at the upper end of the crossing point b, the flat valves D and G being sequentially arranged on the vertical line at the lower end of the crossing point b, the flat valve C being arranged on the parallel line at the right end of the crossing point c, the flat valve F being arranged on the vertical line at the lower end of the crossing point b, the flat valves H and I being arranged on the parallel line at the right end of the crossing point d and the parallel line at the left end of the crossing point e, the hydraulic indicator being arranged on the vertical line at the lower end of the crossing point d, the blowout preventer valve switch indicator being arranged on the vertical line at the lower end of the crossing point e, the flat vales being arranged on the parallel line at the right end of the crossing point e and the parallel line at the left end of the crossing point f, the manual throttle valve being arranged on the vertical line at the lower end of the crossing point f;
crossing points g, h, i, j and k being formed by parallel lines and vertical lines on the high-pressure manifold control zone in a ‘+’ crossing connection manner, the flat valve L being arranged on the vertical line at the upper end of the crossing point h, the flat valve N being arranged on the vertical line at the lower end of the crossing point h, the flat valve M being arranged on the vertical line at the upper end of the crossing point i, the flat valve O being arranged on the vertical line at the lower end of the crossing point i, the flat valve P being arranged on the parallel line at the left end of the crossing point K, and the flat valve Q being arranged on the vertical line at the lower end of the crossing point k;
the choke console comprising a chassis and an internal control circuit board, the front face of the chassis comprising a choke control panel, the choke control panel being provided with a vertical pipe pressure gauge, a sleeve pressure gauge, a throttle valve opening gauge, a display set, a knob set, a switch set, and a light-mounted button set; the display set comprising a pump stroke display, a parameter display A and a parameter display B; the knob set comprising a throttle valve speed-adjusting knob, an increase button A, a decrease button A, an increase button B, a decrease button B, an accelerator adjusting knob and a pump stroke adjusting knob; the switch set comprising a throttle regulating vale switch, a pump clutch switch, a rotary table clutch switch, a cathead selection switch and a roller clutch switch; the light-mounted button set comprising a No. 1 light-mounted button, a No. 2 light-mounted button, a No. 3 light-mounted button, a No. 4 light-mounted button, a No. 5 light-mounted button, a No. 6 light-mounted button, a No. 7 light-mounted button, a No. 8 light-mounted button, a No. 11 light-mounted button, a No. 12 light-mounted button, a No. 13 light-mounted button, a No. 14 light-mounted button, a No. 15 light-mounted button, a No. 16 light-mounted button, a No. 17 light-mounted button and a No. 18 light-mounted button;
the internal control circuit board of the choke console comprising a single chip microcomputer and a peripheral circuit thereof, twenty five switch quantity inputs including the light-mounted button set, the switch set, the increase button A, the decrease button A, the increase button B and the decrease button B being connected with the buffer, the output of the buffer being connected with the latch A, the output of the latch A being connected to one data input/output port of the single chip microcomputer; three analog quantities, including the throttle valve speed-adjusting knob, the accelerator adjusting knob and the pump stroke adjusting knob , being connected with the multipath selector, the output of the multipath selector being connected with the operational amplifier A, the output of the operational amplifier A being connected with the AD converter, the output of the AD converter being connected with the latch A; the input/output port also serving as a data output port, the output of the data output port being connected with the latch B, the output of the latch B being divided into two paths one of which is connected with the DA converter, the output of the DA converter being connected with the operational amplifier B, the output of the operational amplifier B being connected with the field effect transistor, the output of the field effect transistor being connected with the vertical pipe pressure gauge, the sleeve pressure gauge and the throttle valve opening gauge, the other path of the output of the latch B being connected with a parallel port, the output of the parallel port being connected with a pump stroke and parameter display driver, the output of the pump stroke and parameter display driver being connected with the pump stroke display, the parameter display A and the parameter display B; another data input/output port of the single chip microcomputer being connected with the parallel interface, the parallel interface being connected with a driver, the output of the driver being connected with the light-mounted button set; two outputs of the third input/output port of the single chip microcomputer being connected with the address decoder via the latch B, and the output of the address decoder being connected with the parallel interface, and the selection ends of the DA converter and the AD converter respectively;
the main control computer comprising a computer and a main control program running thereon, the graphic computer comprising a computer and a graphic processing program running thereon, the main control program comprising a drilling process module, a system management module, an intelligent scoring module and a communication module, the drilling process module comprising an RIH (Run In Hole) sub-module, a POOH (Pull Out Of Hole) sub-module, a drill-in sub-module, an accident and complex situation handling sub-module, a shut in sub-module, and a killing sub-module; the system management module comprising a system self-inspection and system setting sub-module, the graphic processing program comprising a scene initialization module, a process animation control module, a collision processing module, and a render effect module.

2. The portable drilling simulation system according to claim 1, wherein the pump stroke and parameter display driver comprises an address buffer, a data buffer, a comparator, a decoder, a dip switch, a nixie tube drive chip, and a nixie tube, the input ends of the address buffer and the data buffer being both connected with the parallel port, the output of the data buffer being connected with the nixie tube drive chip, the output of the nixie tube drive chip being connected with the nixie tubes of the pump stroke display, the parameter display A and the parameter display B respectively; the output of the address buffer being connected with the comparator and the decoder respectively, the other input end of the comparator being connected with the dip switch, the output of the comparator being connected with the enabling end of the decoder, one output end of the decoder being connected with the writing control end of the nixie tube drive chip, the other output end of the decoder being connected with the mode control end of the nixie tube drive chip via a trigger.
